(19) United States
(12) Patent Application Publication
(10) Pub. No.: US 2019/0163355 A1
(43) Pub. Date: May 30, 2019

(54) PERSONA-BASED DASHBOARD IN AN AUTOMATED-APPLICATION-RELEASE-MANAGEMENT SUBSYSTEM

(71) Applicant: VMWARE, INC., Palo Alto, CA (US)

(72) Inventors: Agila Govindaraju, Bangalore (IN); Karthikeyan Ramasamy, Bangalore (IN)

(21) Appl. No.: 15/899,380

(22) Filed: Feb. 20, 2018

(30) Foreign Application Priority Data
Nov. 30, 2017 (IN) 201741043042

(51) Int. Cl. G06F 3/0484; G06F 8/60; G06F 8/77; H04L 12/24; G06F 3/0481

(52) U.S. Cl. CPC G06F 3/04847; G06F 8/60; G06Q 10/103; H04L 41/22; G06F 3/0481; G06F 8/77

(57) ABSTRACT

The current document is directed to an automated-application-release-management system that organizes and manages the application-development and application-release processes to allow for continuous application development and release. The current document is particularly directed to implementations in which the automated application-release-management subsystem provides persona-based dashboard displays to users, tailoring the dashboard displays to the job profiles of users and to individual users. Persona-based dashboard displays are facilitated by standardized stage and task outputs, output contexts implemented by code-change identifiers, and stage/task-output aggregation.

### RELATED APPLICATIONS

Benefit is claimed under 35 U.S.C. 119(a)-(d) to Foreign Application Serial No. 201741043042 filed in India entitled “PERSONA-BASED DASHBOARD IN AN AUTOMATED-APPLICATION-RELEASE-MANAGEMENT SUBSYSTEM”, on Nov. 30, 2017, by VMware, Inc., which is herein incorporated in its entirety by reference for all purposes.

### TECHNICAL FIELD

The current document is directed to automated application-release-management facilities and, in particular, to an automated application-release-management facility provides persona-based dashboard displays to users.

### BACKGROUND

Early computer systems were generally large, single-processor systems that sequentially executed jobs encoded on huge decks of Hollerith cards. Over time, the parallel evolution of computer hardware and software produced main-frame computers and minicomputers with multi-tasking operation systems, increasingly capable personal computers, workstations, and servers, and, in the current environment, multi-processor mobile computing devices, personal computers, and servers interconnected through global networking and communications systems with one another and with massive virtual data centers and virtualized cloud-computing facilities. This rapid evolution of computer systems has been accompanied with greatly expanded needs for computer-system management and administration. Currently, these needs have begun to be addressed by highly capable automated management and administration tools and facilities. As with many other types of computational systems and facilities, from operating systems to applications, many different types of automated administration and management facilities have emerged, providing many different products with overlapping functionalities, but each also providing unique functionalities and capabilities. Owners, managers, and users of large-scale computer systems continue to seek methods and technologies to provide efficient and cost-effective management and administration of cloud-computing facilities and other large-scale computer systems.

### SUMMARY

The current document is directed to an automated-application-release-management system that organizes and manages the application-development and application-release processes to allow for continuous application development and release. The current document is particularly directed to implementations in which the automated application-release-management subsystem provides persona-based dashboard displays to users, tailoring the dashboard displays to the job profiles of users and to individual users. Persona-based dashboard displays are facilitated by standardized stage and task outputs, output contexts implemented by code-change identifiers, and stage/task-output aggregation.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a workflow-based cloud-management facility that has been developed to provide a powerful administrative and development interface to multiple multi-tenant cloud-computing facilities.

FIG. 12 provides an architectural diagram of the workflow-execution engine and development environment.

FIGS. 13A-C illustrate the structure of a workflow.

FIGS. 14A-B include a table of different types of elements that may be included in a workflow.

FIGS. 15A-B show an example workflow.

FIGS. 16A-C illustrate an example implementation and configuration of virtual appliances within a cloud-computing facility that implement the workflow-based management and administration facilities of the above-described WFMAD.

FIGS. 16D-F illustrate the logical organization of users and user roles with respect to the infrastructure-management-and-administration facility of the WFMAD.

FIG. 17 illustrates the logical components of the infrastructure-management-and-administration facility of the WFMAD.

FIGS. 18-20B provide a high-level illustration of the architecture and operation of the automated-application-release-management facility of the WFMAD.

FIG. 21 illustrates additional details with respect to particular type of application-release-management-pipeline stage that is used in pipelines executed by a particular class of implementations of the automated application-release-management subsystem.

FIGS. 22 A-B illustrate a highly modularized automated application-release-management subsystem using illustration conventions similar to those used in FIG. 18.

FIG. 23A alternatively illustrates a simple application-release-management pipeline.

FIG. 23B illustrates the processes carried out by the application-release-management pipeline illustrated in FIG. 23A.

FIGS. 24A-C illustrate certain problems associated with data output by the automated application-release-management subsystem.

FIG. 25 illustrates different types of dashboard interfaces to different types of users of the automated application-release-management subsystem.

FIGS. 26A-E illustrate various approaches used to construct persona-based dashboard displays that address certain of the problems associated with the types and quantities of data output by an automated application-release-management subsystem.

FIGS. 27A-D Illustrate implementation of a persona-based dashboard by an automated application-release-management subsystem.

### DETAILED DESCRIPTION OF EMBODIMENTS

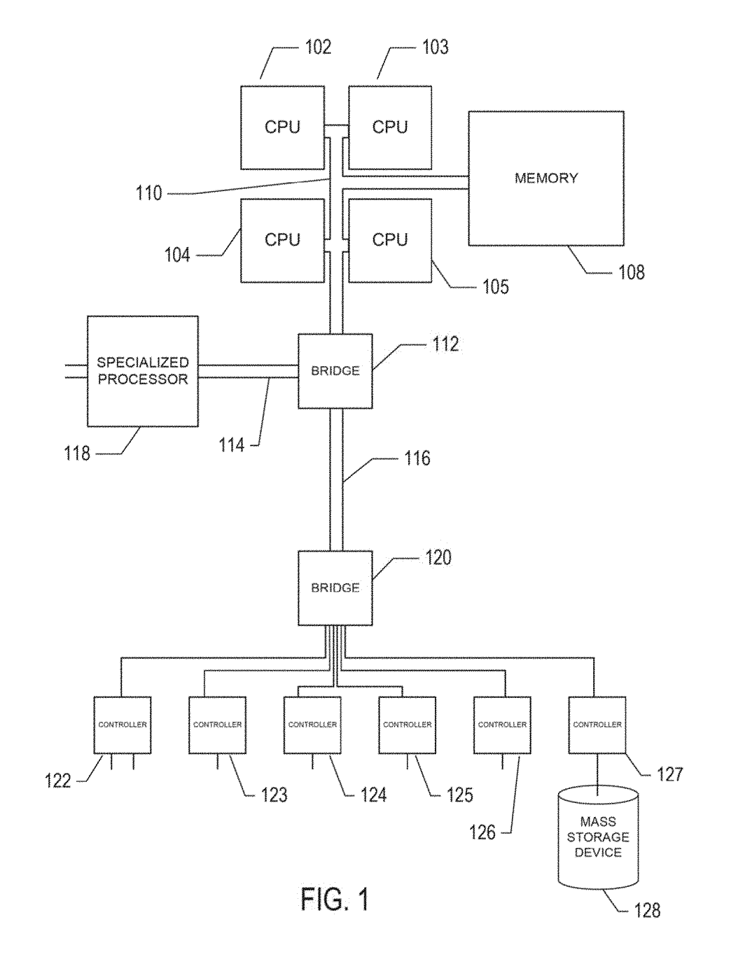

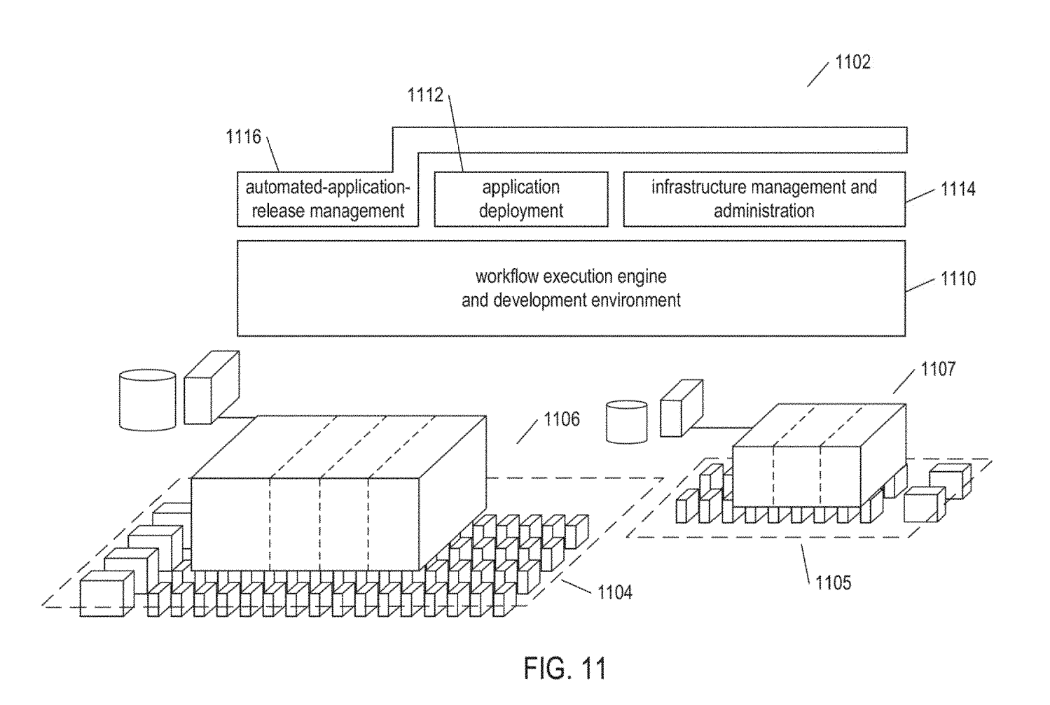

The current document is directed to an automated application-release-management subsystem of a workflow-based cloud-management facility. In a first subsection, below, a detailed description of computer hardware, complex computational systems, and virtualization is provided with reference to FIGS. 1-10. In a second subsection, an overview of a workflow-based cloud-management facility is provided with reference to FIGS. 11-22B. In a third subsection, implementations of the currently disclosed persona dashboard are discussed.

Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

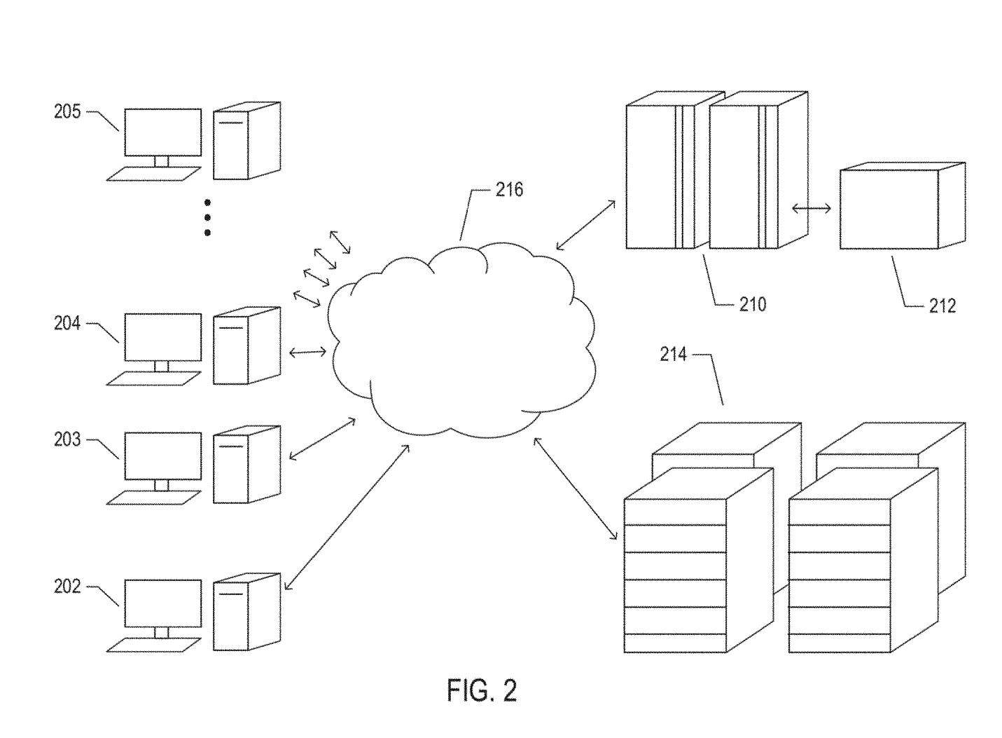

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

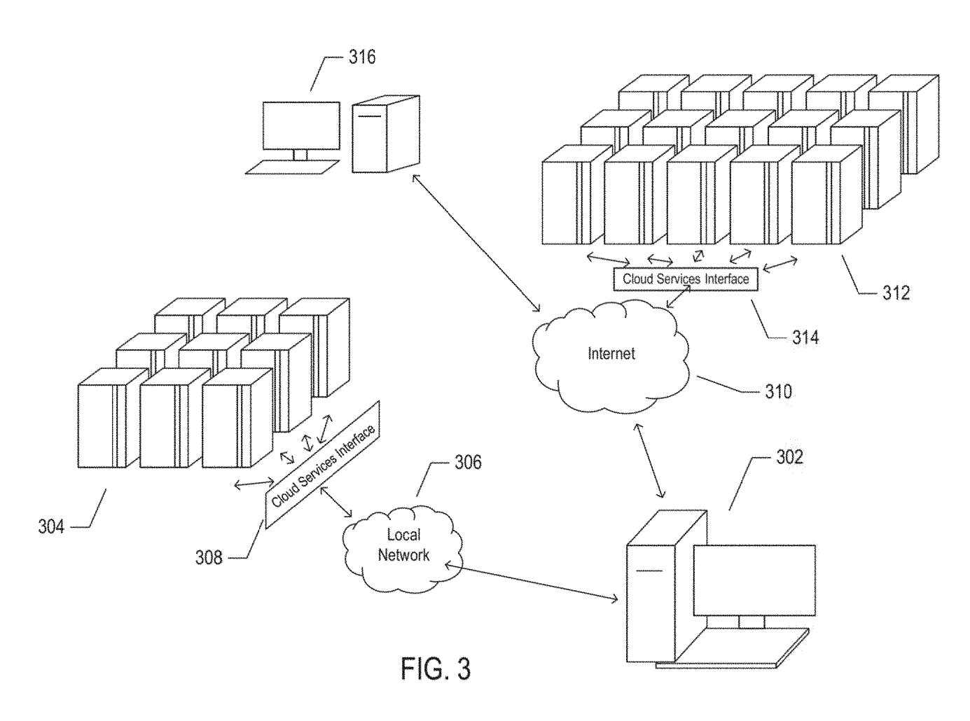

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

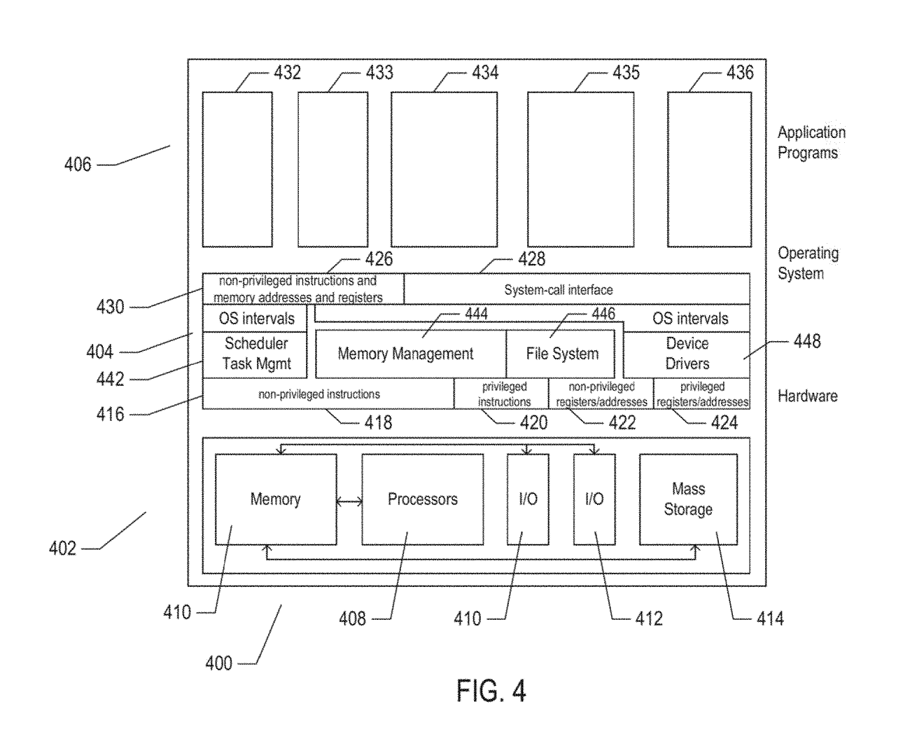

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

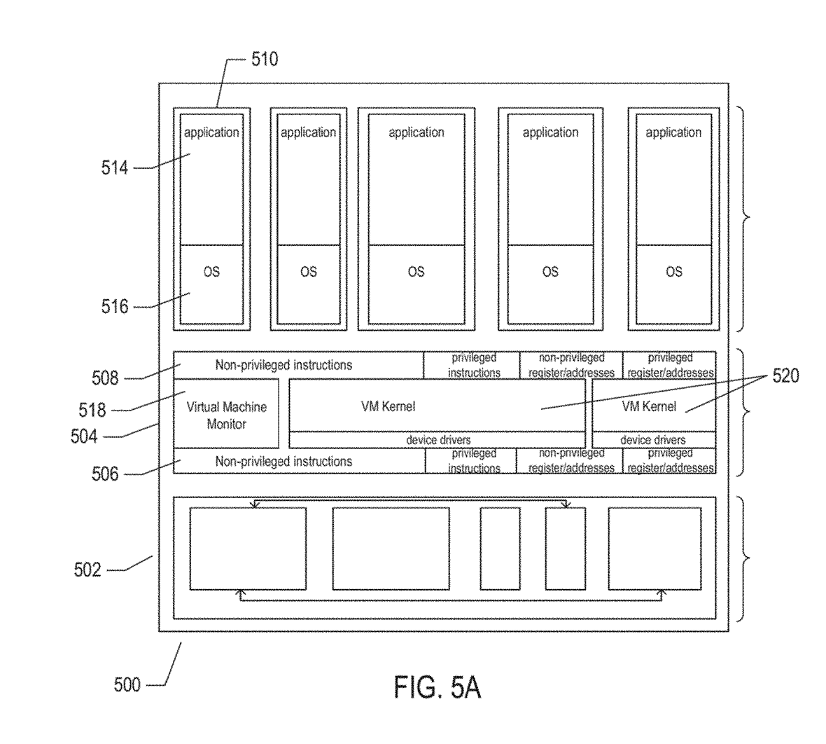

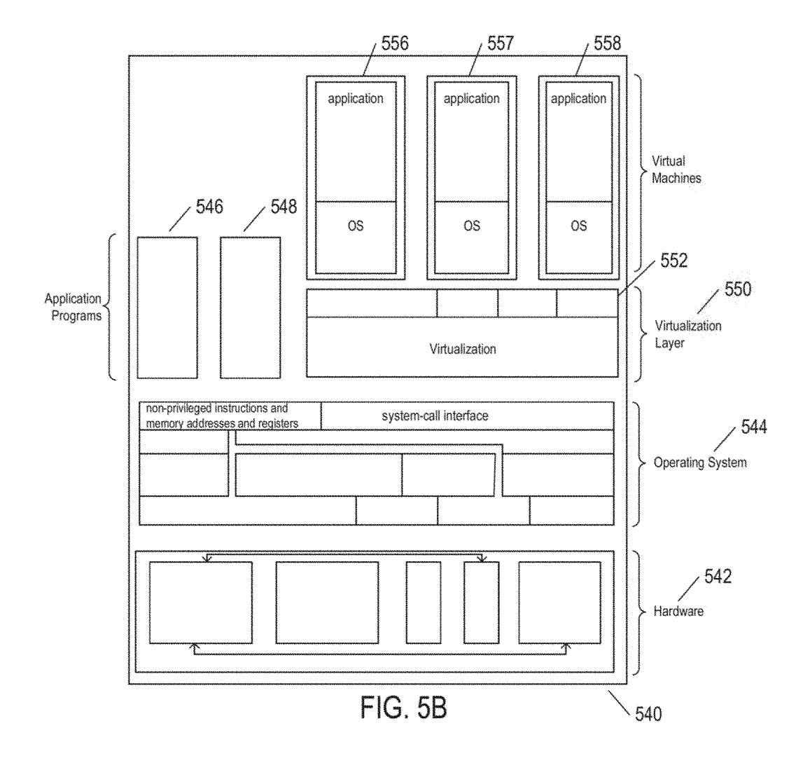

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

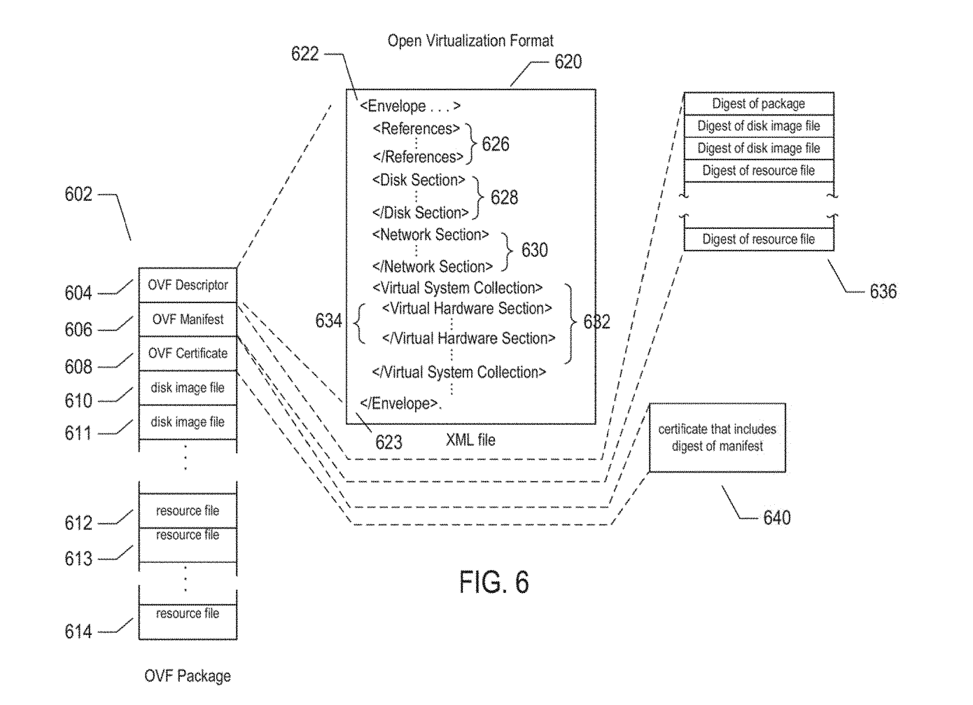

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

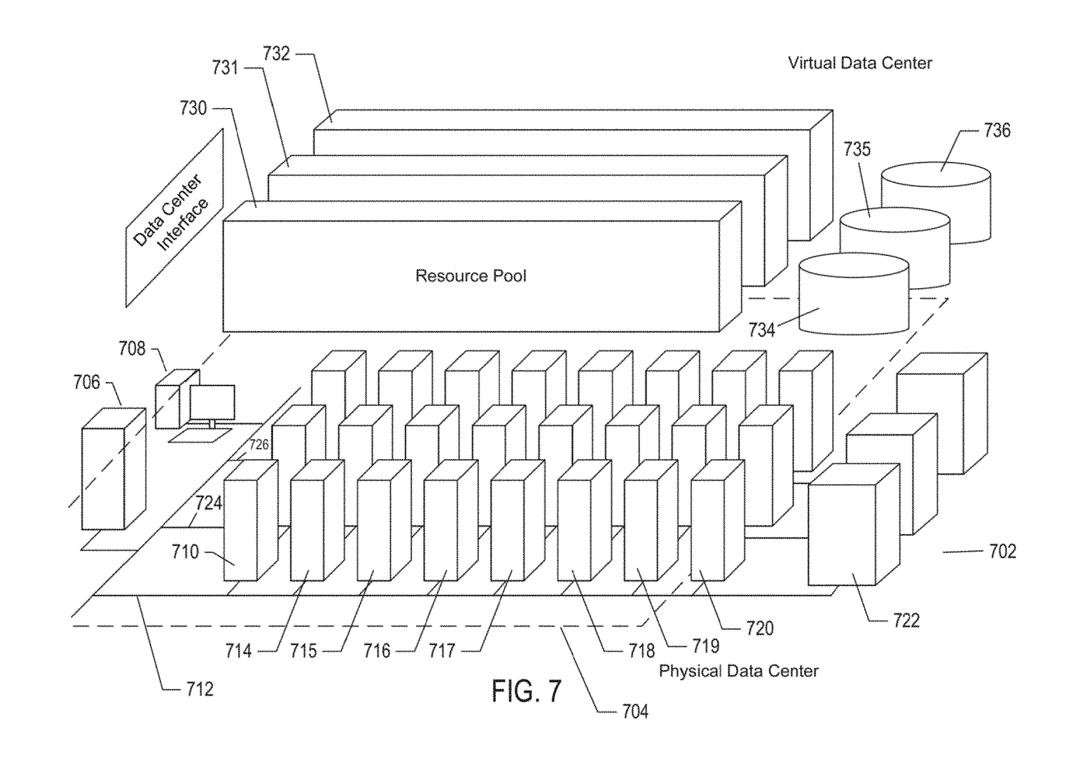

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

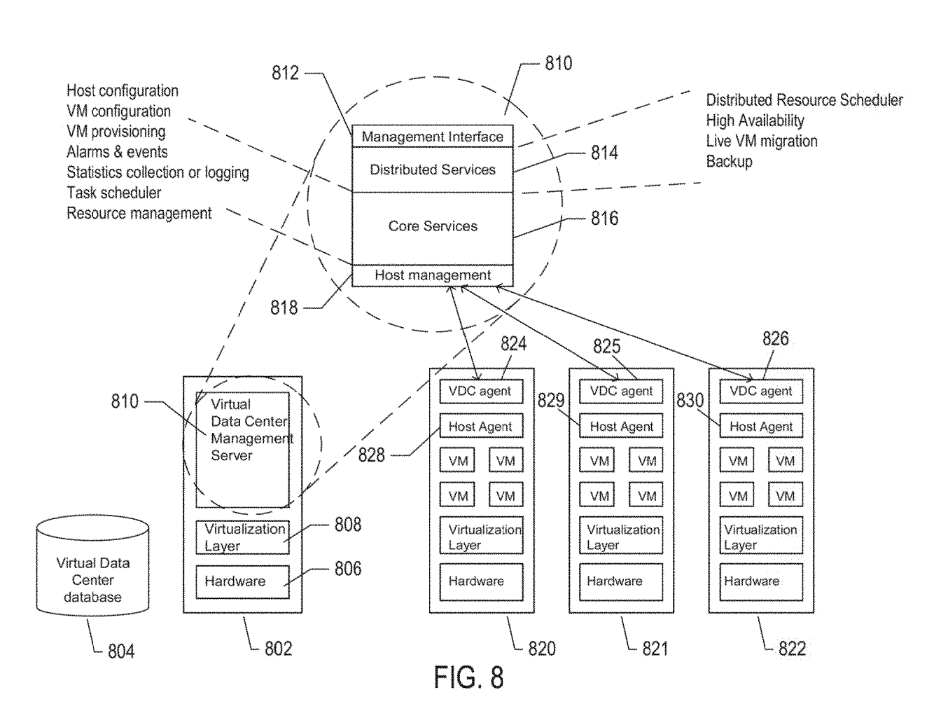

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808, and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

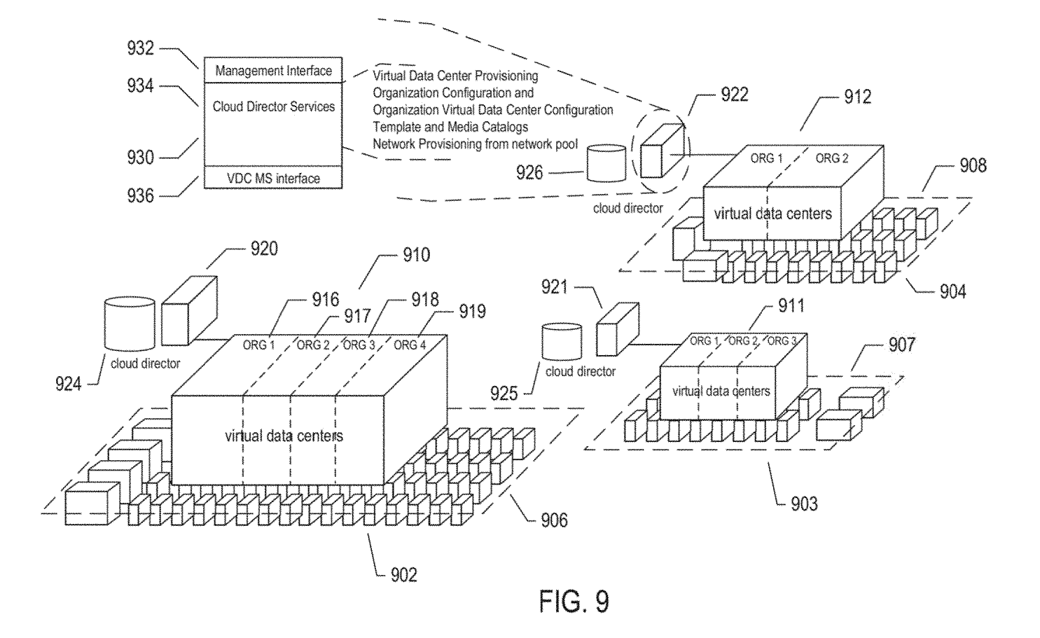

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

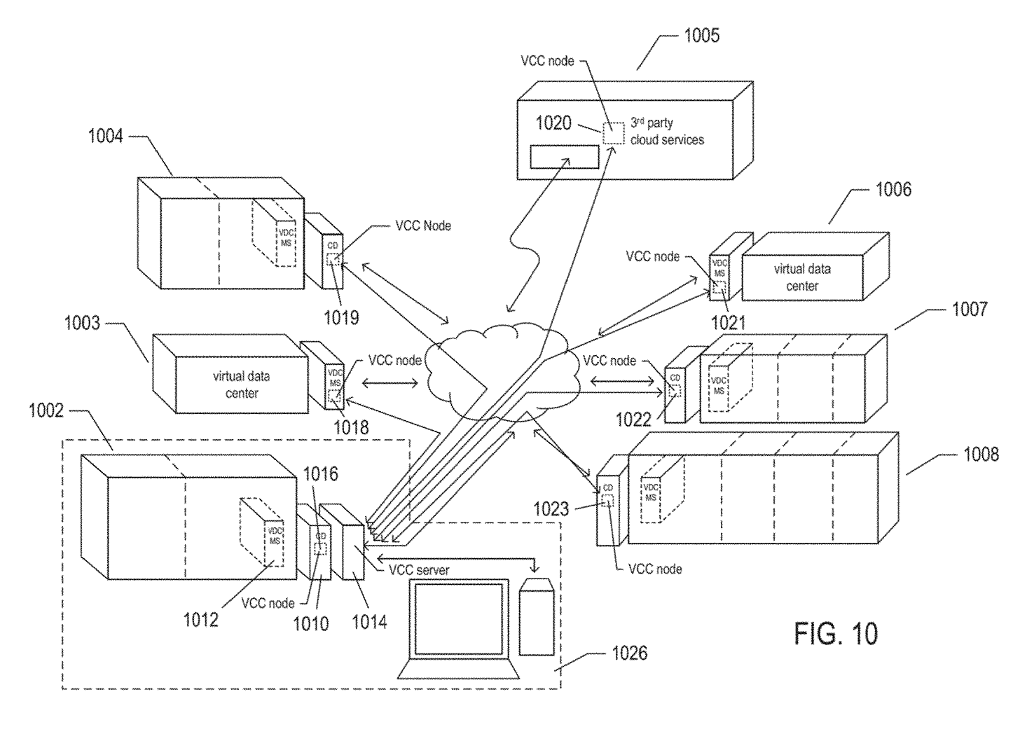

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Workflow-Based Cloud Management

FIG. 11 shows workflow-based cloud-management facility that has been developed to provide a powerful administrative and development interface to multiple multi-tenant cloud-computing facilities. The workflow-based management, administration, and development facility (“WFMAD”) is used to manage and administer cloud-computing aggregations, such as those discussed above with reference to FIG. 10, cloud-computing aggregations, such as those discussed above with reference to FIG. 9, and a variety of additional types of cloud-computing facilities as well as to deploy applications and continuously and automatically release complex applications on various types of cloud-computing aggregations. As shown in FIG. 11, the WFMAD 1102 is implemented above the physical hardware layers 1104 and 1105 and virtual data centers 1106 and 1107 of a cloud-computing facility or cloud-computing-facility aggregation. The WFMAD includes a workflow-execution engine and development environment 1110, an application-deployment facility 1112, an infrastructure-management-and-administration facility 1114, and an automated-application-release-management facility 1116. The workflow-execution engine and development environment 1110 provides an integrated development environment for constructing, validating, testing, and executing graphically expressed workflows, discussed in detail below. Workflows are high-level programs with many built-in functions, scripting tools, and development tools and graphical interfaces. Workflows provide an underlying foundation for the infrastructure-management-and-administration facility 1114, the application-development facility 1112, and the automated-application-release-management facility 1116. The infrastructure-management-and-administration facility 1114 provides a powerful and intuitive suite of management and administration tools that allow the resources of a cloud-computing facility or cloud-computing-facility aggregation to be distributed among clients and users of the cloud-computing facility or facilities and to be administered by a hierarchy of general and specific administrators. The infrastructure-management-and-administration facility 1114 provides interfaces that allow service architects to develop various types of services and resource descriptions that can be provided to users and clients of the cloud-computing facility or facilities, including many management and administrative services and functionalities implemented as workflows. The application-deployment facility 1112 provides an integrated application-deployment environment to facilitate building and launching complex cloud-resident applications on the cloud-computing facility or facilities. The application-deployment facility provides access to one or more artifact repositories that store and logically organize binary files and other artifacts used to build complex cloud-resident applications as well as access to automated tools used, along with workflows, to develop specific automated application-deployment tools for specific cloud-resident applications. The automated-application-release-management facility 1116 provides workflow-based automated release-management tools that enable cloud-resident-application developers to continuously generate application releases produced by automated deployment, testing, and validation functionalities. Thus, the WFMAD 1102 provides a powerful, programmable, and extensible management, administration, and development platform to allow cloud-computing facilities and cloud-computing-facility aggregations to be used and managed by organizations and teams of individuals.

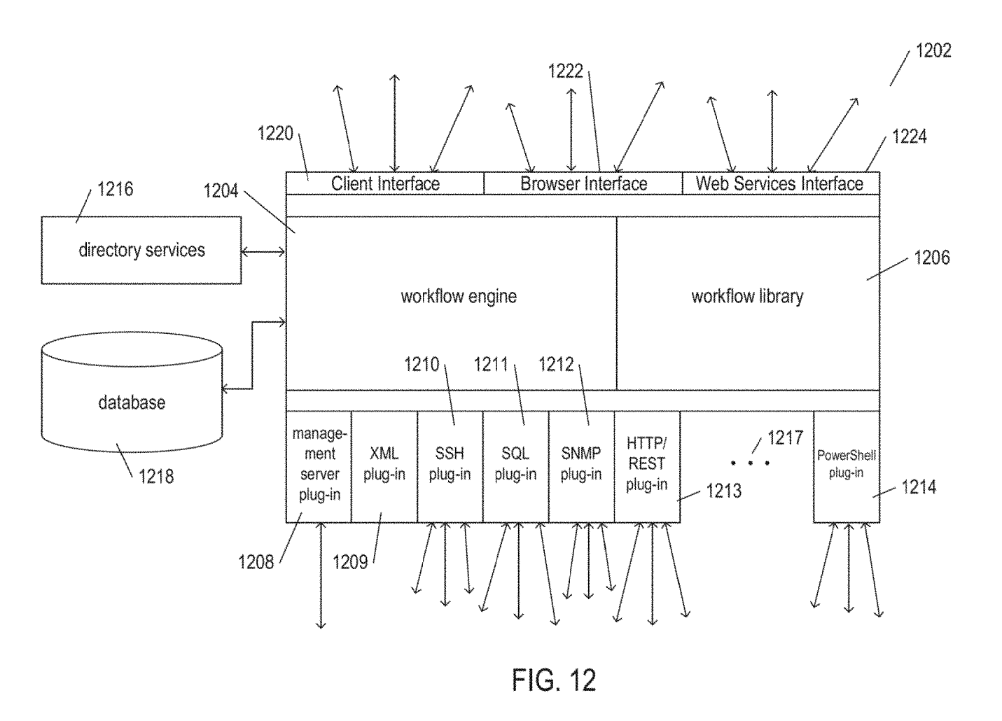

Next, the workflow-execution engine and development environment is discussed in grater detail. FIG. 12 provides an architectural diagram of the workflow-execution engine and development environment. The workflow-execution engine and development environment 1202 includes a workflow engine 1204, which executes workflows to carry out the many different administration, management, and development tasks encoded in workflows that comprise the functionalities of the WFMAD. The workflow engine, during execution of workflows, accesses many built-in tools and functionalities provided by a workflow library 1206. In addition, both the routines and functionalities provided by the workflow library and the workflow engine access a wide variety of tools and computational facilities, provided by a wide variety of third-party providers, through a large set of plug-ins 1208-1214. Note that the ellipses 1216 indicate that many additional plug-ins provide, to the workflow engine and workflow-library routines, access to many additional third-party computational resources. Plug-in 1208 provides for access, by the workflow engine and workflow-library routines, to a cloud-computing-facility or cloud-computing-facility-aggregation management server, such as a cloud director (920 in FIG. 9) or VCC server (1014 in FIG. 10). The XML plug-in 1209 provides access to a complete document object model (“DOM”) extensible markup language (“XML”) parser. The SSH plug-in 1210 provides access to an implementation of the Secure Shell v2 (“SSH-2”) protocol. The structured query language (“SQL”) plug-in 1211 provides access to a Java database connectivity (“JDBC”) API that, in turn, provides access to a wide range of different types of databases. The simple network management protocol (“SNMP”) plug-in 1212 provides access to an implementation of the SNMP protocol that allows the workflow-execution engine and development environment to connect to, and receive information from, various SNMP-enabled systems and devices. The hypertext transfer protocol (“HTTP”)/representational state transfer (′REST″) plug-in 1213 provides access to REST web services and hosts. The PowerShell plug-in 1214 allows the workflow-execution engine and development environment to manage PowerShell hosts and run custom PowerShell operations. The workflow engine 1204 additionally accesses directory services 1216, such as a lightweight directory access protocol (“LDAP”) directory, that maintain distributed directory information and manages password-based user login. The workflow engine also accesses a dedicated database 1218 in which workflows and other information are stored. The workflow-execution engine and development environment can be accessed by clients running a client application that interfaces to a client interface 1220, by clients using web browsers that interface to a browser interface 1222, and by various applications and other executables running on remote computers that access the workflow-execution engine and development environment using a REST or small-object-access protocol (“SOAP”) via a web-services interface 1224. The client application that runs on a remote computer and interfaces to the client interface 1220 provides a powerful graphical user interface that allows a client to develop and store workflows for subsequent execution by the workflow engine. The user interface also allows clients to initiate workflow execution and provides a variety of tools for validating and debugging workflows. Workflow execution can be initiated via the browser interface 1222 and web-services interface 1224. The various interfaces also provide for exchange of data output by workflows and input of parameters and data to workflows.

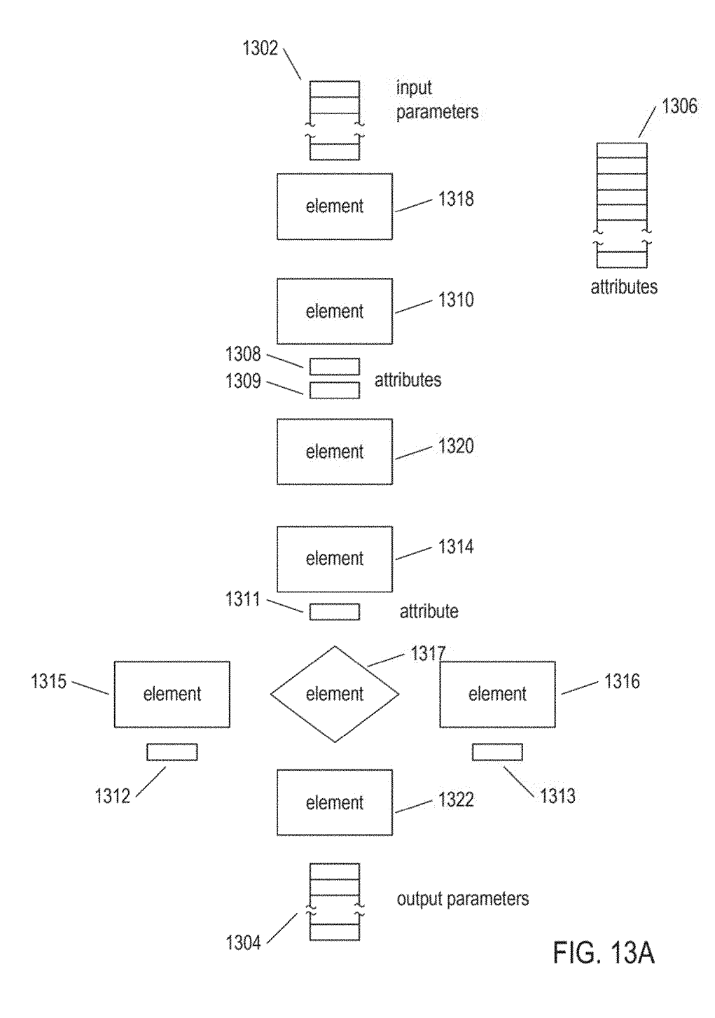

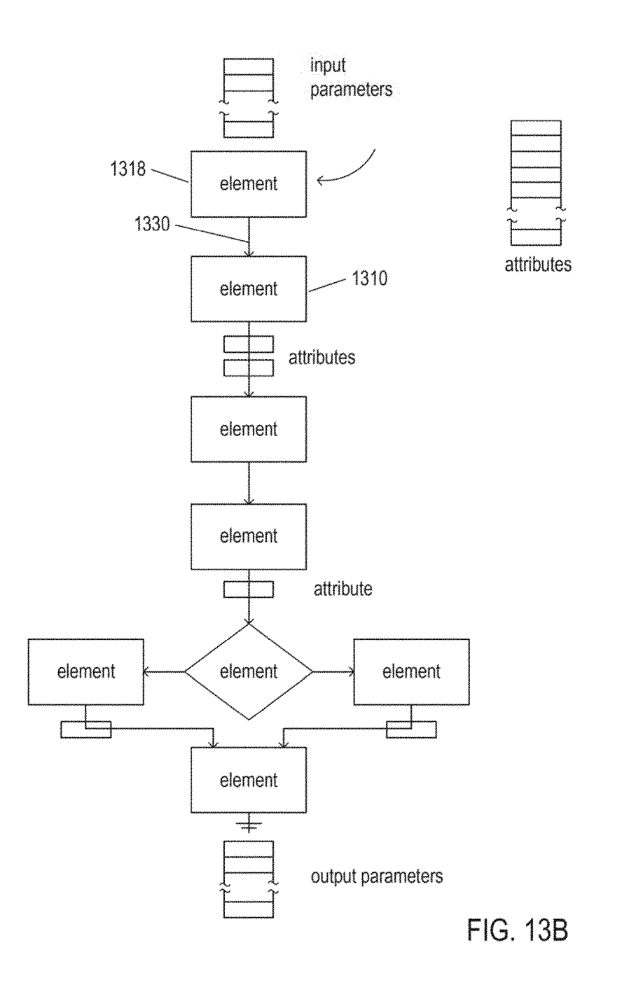

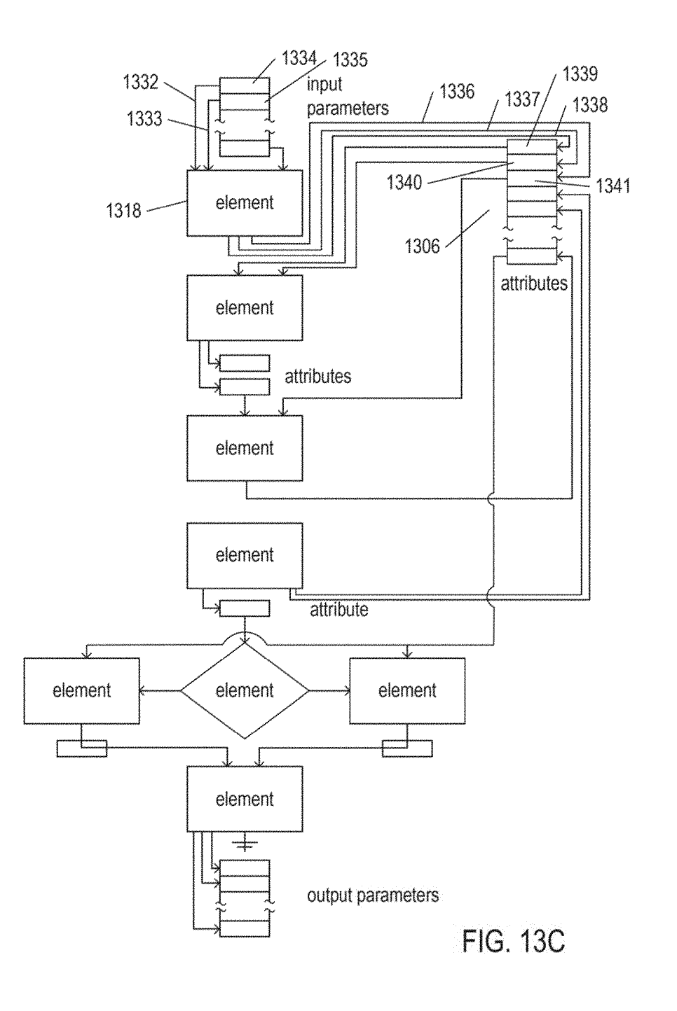

FIGS. 13A-C illustrate the structure of a workflow. A workflow is a graphically represented high-level program. FIG. 13A shows the main logical components of a workflow. These components include a set of one or more input parameters 1302 and a set of one or more output parameters 1304. In certain cases, a workflow may not include input and/or output parameters, but, in general, both input parameters and output parameters are defined for each workflow. The input and output parameters can have various different data types, with the values for a parameter depending on the data type associated with the parameter. For example, a parameter may have a string data type, in which case the values for the parameter can include any alphanumeric string or Unicode string of up to a maximum length. A workflow also generally includes a set of parameters 1306 that store values manipulated during execution of the workflow. This set of parameters is similar to a set of global variables provided by many common programming languages. In addition, attributes can be defined within individual elements of a workflow, and can be used to pass values between elements. In FIG. 13A, for example, attributes 1308-1309 are defined within element 1310 and attributes 1311, 1312, and 1313 are defined within elements 1314, 1315, and 1316, respectively. Elements, such as elements 1318, 1310, 1320, 1314-1316, and 1322 in FIG. 13A, are the execution entities within a workflow. Elements are equivalent to one or a combination of common constructs in programming languages, including subroutines, control structures, error handlers, and facilities for launching asynchronous and synchronous procedures. Elements may correspond to script routines, for example, developed to carry out an almost limitless number of different computational tasks. Elements are discussed, in greater detail, below.

As shown in FIG. 13B, the logical control flow within a workflow is specified by links, such as link 1330 which indicates that element 1310 is executed following completion of execution of element 1318. In FIG. 13B, links between elements are represented as single-headed arrows. Thus, links provide the logical ordering that is provided, in a common programming language, by the sequential ordering of statements. Finally, as shown in FIG. 13C, bindings that bind input parameters, output parameters, and attributes to particular roles with respect to elements specify the logical data flow in a workflow. In FIG. 13C, single-headed arrows, such as single-headed arrow 1332, represent bindings between elements and parameters and attributes. For example, bindings 1332 and 1333 indicate that the values of the first input parameters 1334 and 1335 are input to element 1318. Thus, the first two input parameters 1334-1335 play similar roles as arguments to functions in a programming language. As another example, the bindings represented by arrows 1336-1338 indicate that element 1318 outputs values that are stored in the first three attributes 1339, 1340, and 1341 of the set of attributes 1306.

Thus, a workflow is a graphically specified program, with elements representing executable entities, links representing logical control flow, and bindings representing logical data flow. A workflow can be used to specific arbitrary and arbitrarily complex logic, in a similar fashion as the specification of logic by a compiled, structured programming language, an interpreted language, or a script language.

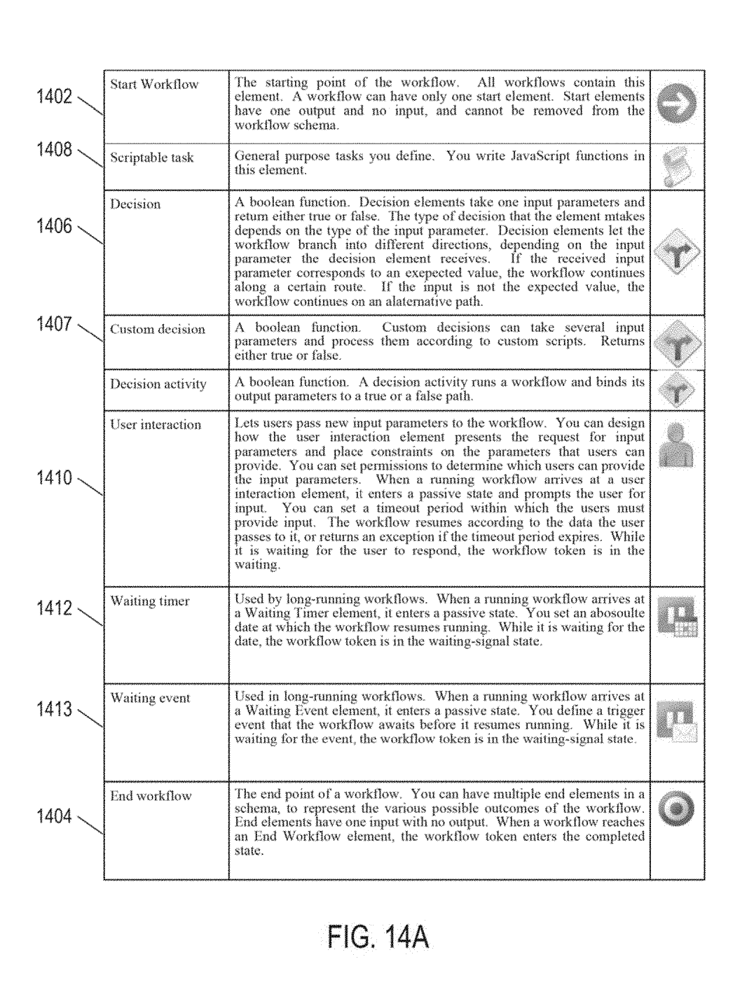

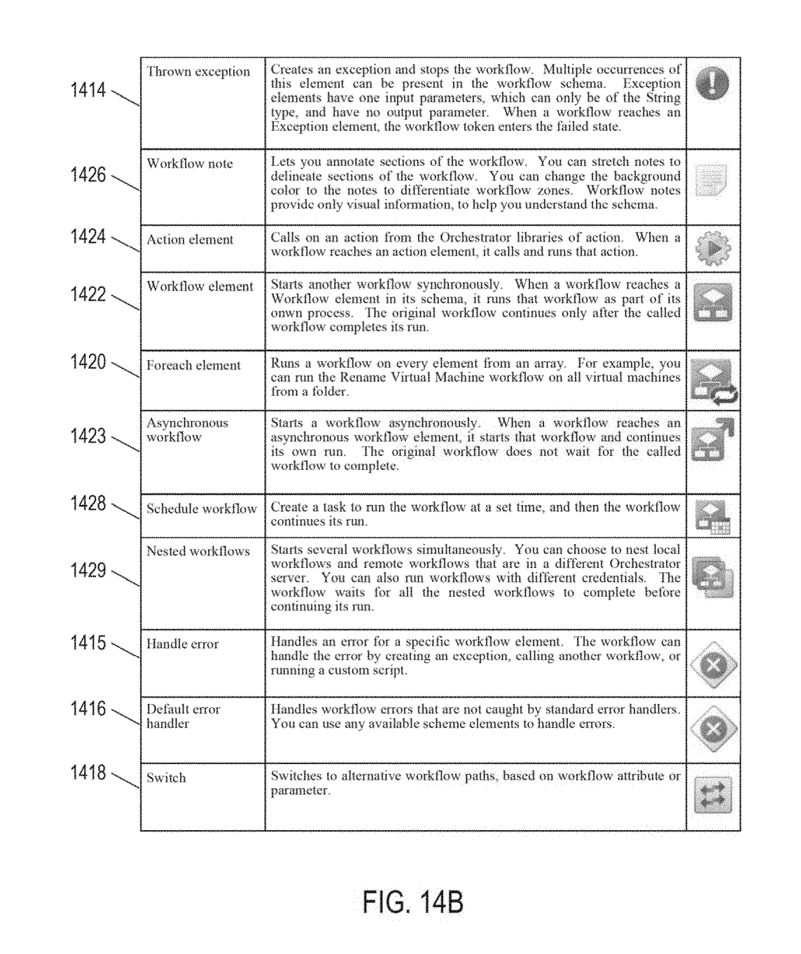

FIGS. 14A-B include a table of different types of elements that may be included in a workflow. Workflow elements may include a start-workflow element 1402 and an end-workflow element 1404, examples of which include elements 1318 and 1322, respectively, in FIG. 13A. Decision workflow elements 1406-1407, an example of which is element 1317 in FIG. 13A, function as an if-then-else construct commonly provided by structured programming languages. Scriptable-task elements 1408 are essentially script routines included in a workflow. A user-interaction element 1410 solicits input from a user during workflow execution. Waiting-timer and waiting-event elements 1412-1413 suspend workflow execution for a specified period of time or until the occurrence of a specified event. Thrown-exception elements 1414 and error-handling elements 1415-1416 provide functionality commonly provided by throw-catch constructs in common programming languages. A switch element 1418 dispatches control to one of multiple paths, similar to switch statements in common programming languages, such as C and C++. A for each element 1420 is a type of iterator. External workflows can be invoked from a currently executing workflow by a workflow element 1422 or asynchronous-workflow element 1423. An action element 1424 corresponds to a call to a workflow-library routine. A workflow-note element 1426 represents a comment that can be included within a workflow. External workflows can also be invoked by schedule-workflow and nested-workflows elements 1428 and 1429.

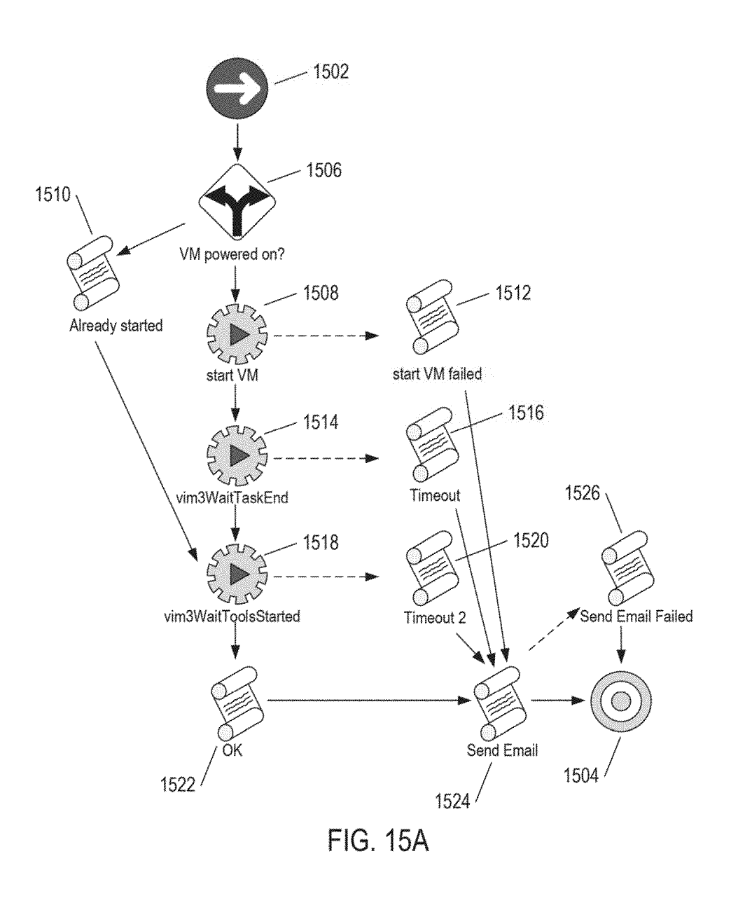

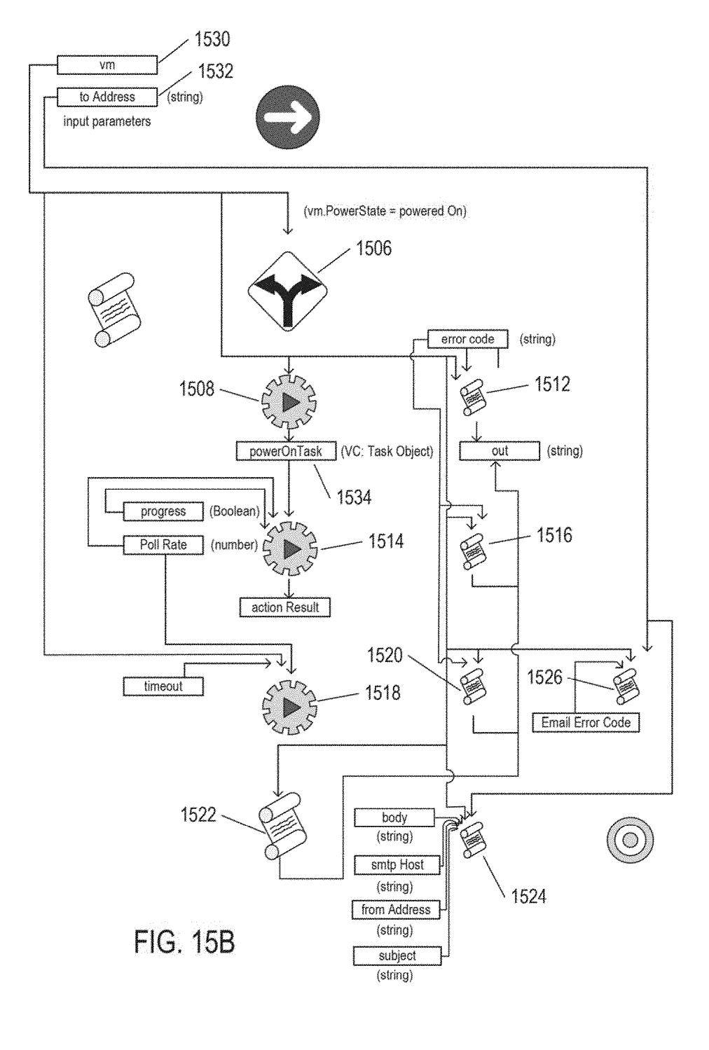

FIGS. 15A-B show an example workflow. The workflow shown in FIG. 15A is a virtual-machine-starting workflow that prompts a user to select a virtual machine to start and provides an email address to receive a notification of the outcome of workflow execution. The prompts are defined as input parameters. The workflow includes a start-workflow element 1502 and an end-workflow element 1504. The decision element 1506 checks to see whether or not the specified virtual machine is already powered on. When the VM is not already powered on, control flows to a start-VM action 1508 that calls a workflow-library function to launch the VM. Otherwise, the fact that the VM was already powered on is logged, in an already-started scripted element 1510. When the start operation fails, a start-VM-failed scripted element 1512 is executed as an exception handler and initializes an email message to report the failure. Otherwise, control flows to a vim3WaitTaskEnd action element 1514 that monitors the VM-starting task. A timeout exception handler is invoked when the start-VM task does not finish within a specified time period. Otherwise, control flows to a vim3WaitToolsStarted task 1518 which monitors starting of a tools application on the virtual machine. When the tools application fails to start, then a second timeout exception handler is invoked 1520. When all the tasks successfully complete, an OK scriptable task 1522 initializes an email body to report success. The email that includes either an error message or a success message is sent in the send-email scriptable task 1524. When sending the email fails, an email exception handler 1526 is called. The already-started, OK, and exception-handler scriptable elements 1510, 1512, 1516, 1520, 1522, and 1526 all log entries to a log file to indicate various conditions and errors. Thus, the workflow shown in FIG. 15A is a simple workflow that allows a user to specify a VM for launching to run an application.

FIG. 15B shows the parameter and attribute bindings for the workflow shown in FIG. 15A. The VM to start and the address to send the email are shown as input parameters 1530 and 1532. The VM to start is input to decision element 1506, start-VM action element 1508, the exception handlers 1512, 1516, 1520, and 1526, the send-email element 1524, the OK element 1522, and the vim3WaitToolsStarted element 1518. The email address furnished as input parameter 1532 is input to the email exception handler 1526 and the send-email element 1524. The VM-start task 1508 outputs an indication of the power on task initiated by the element in attribute 1534 which is input to the vim3WaitTaskEnd action element 1514. Other attribute bindings, input, and outputs are shown in FIG. 15B by additional arrows.

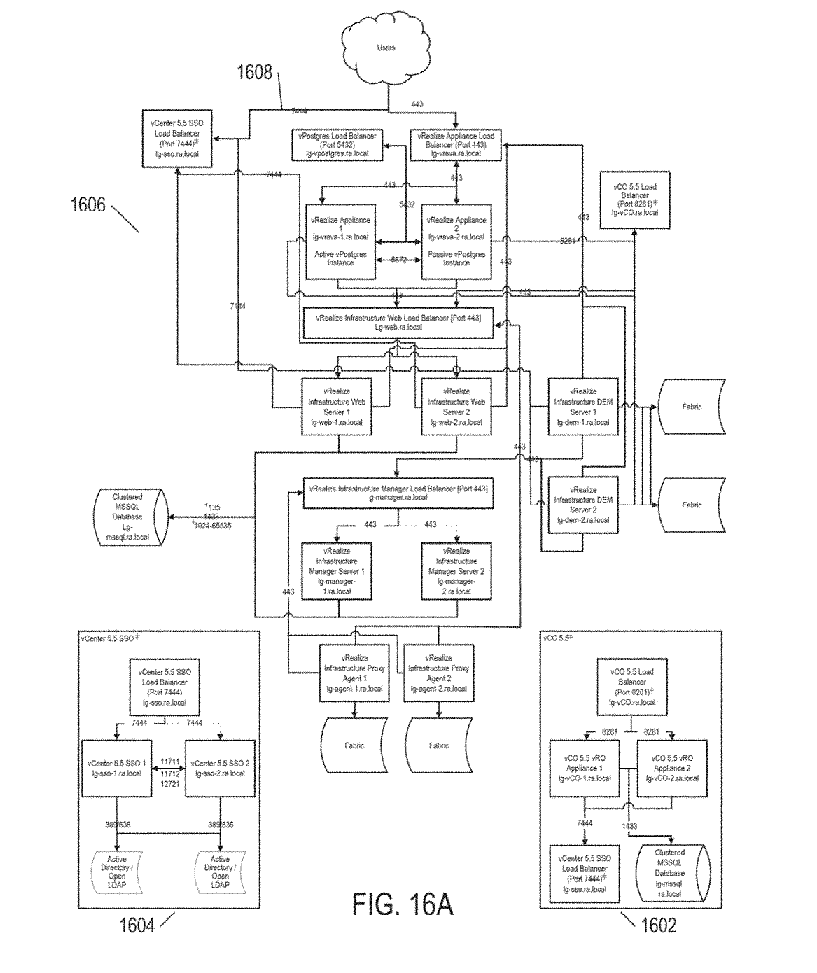

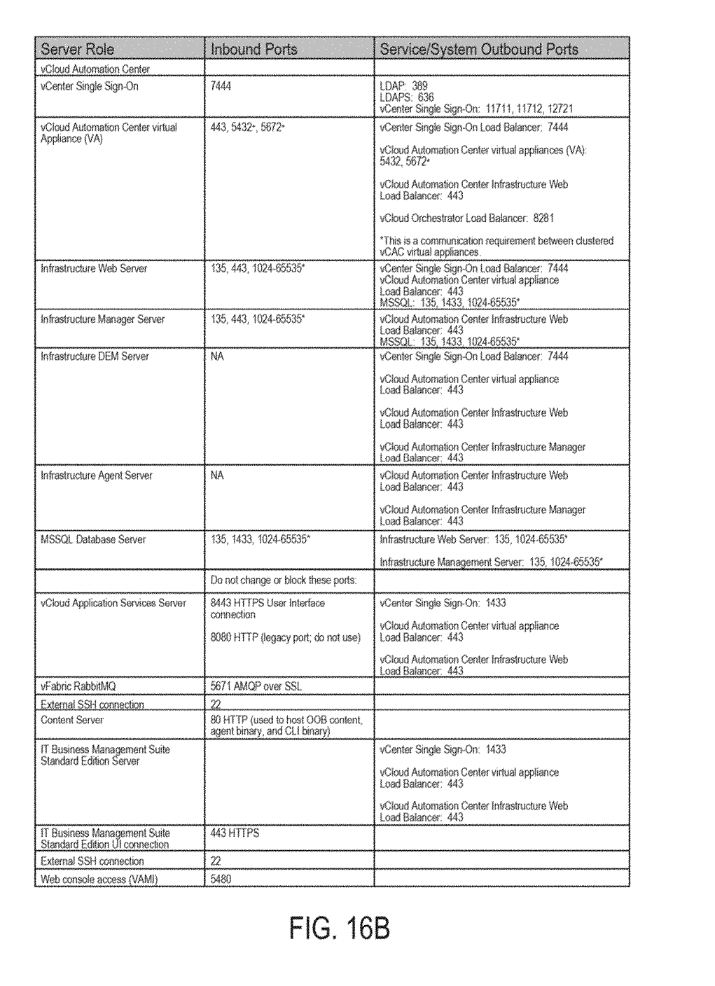

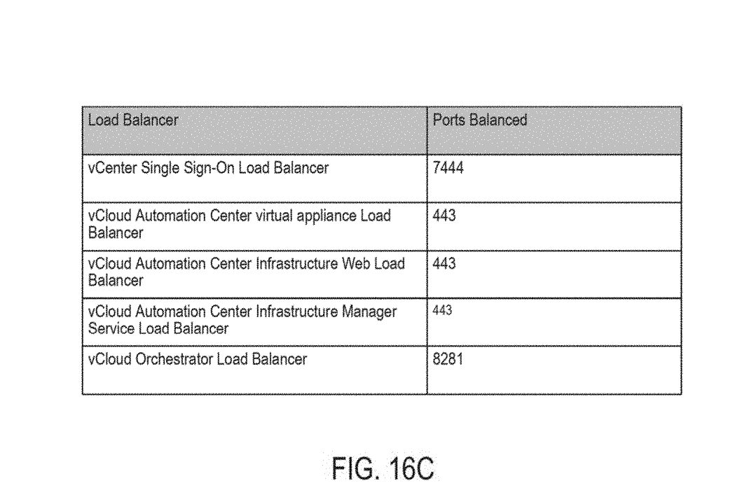

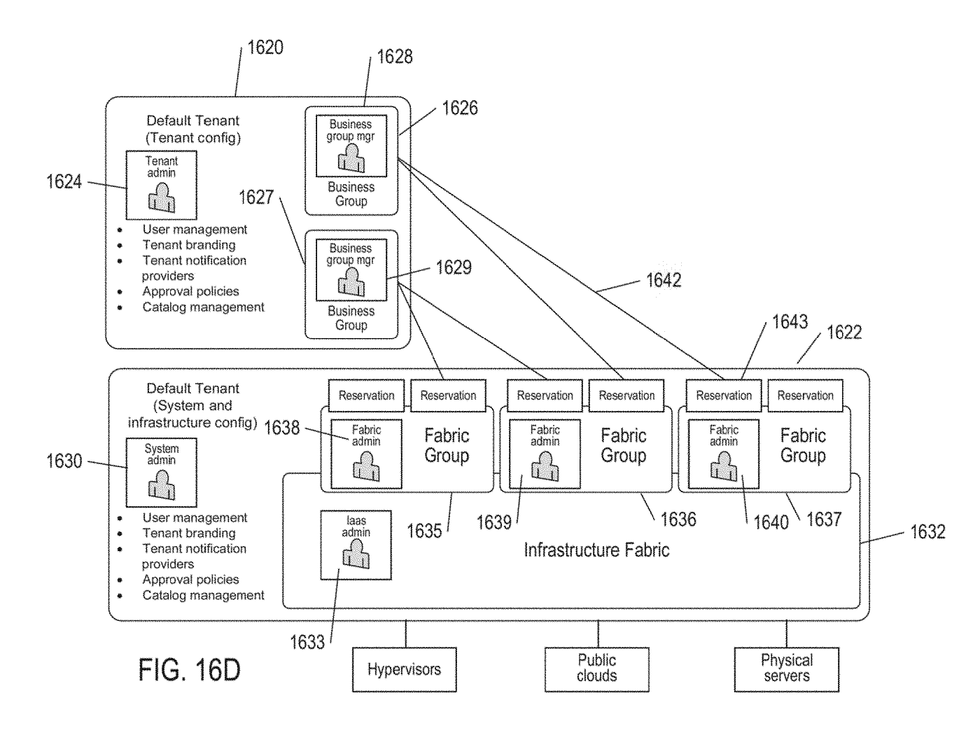

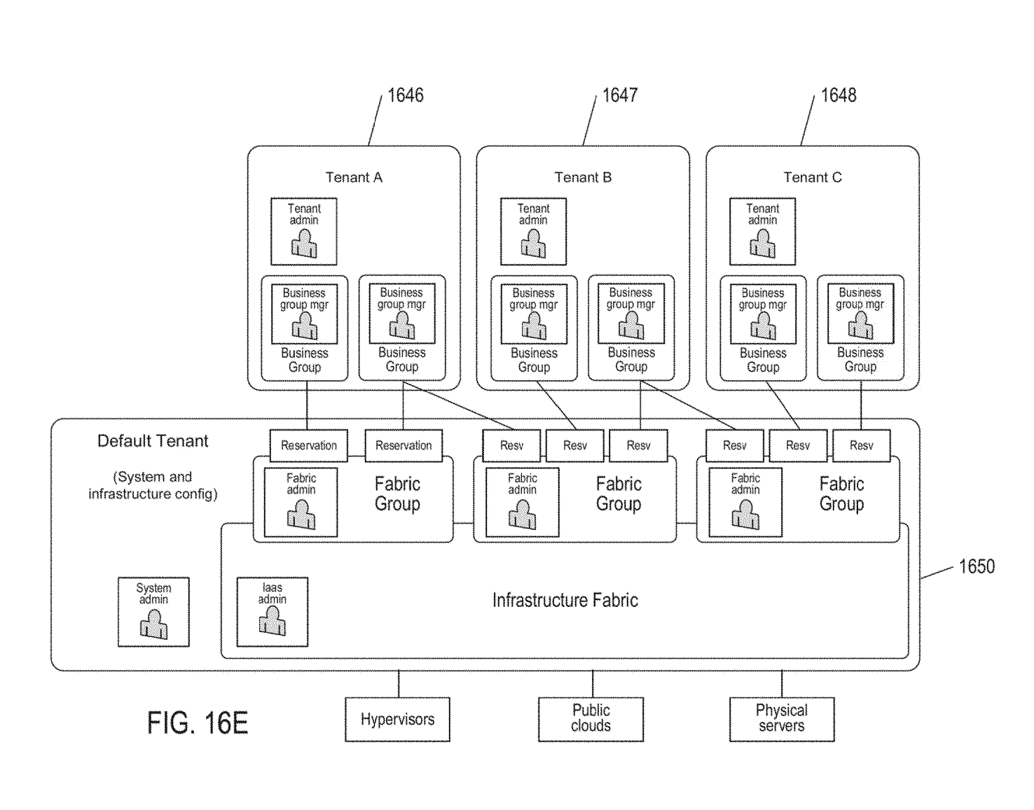

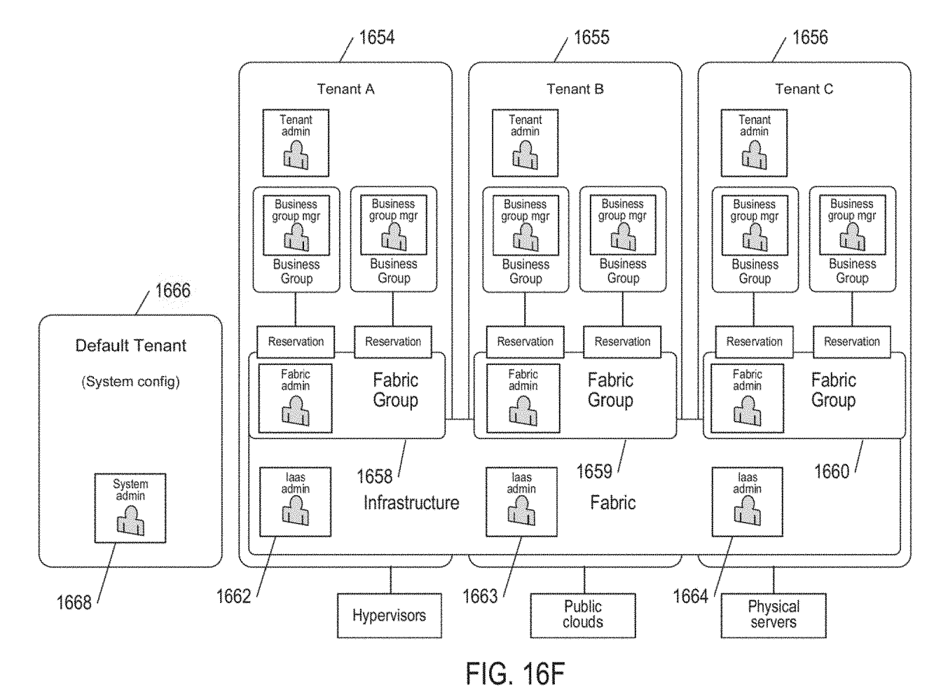

FIGS. 16A-C illustrate an example implementation and configuration of virtual appliances within a cloud-computing facility that implement the workflow-based management and administration facilities of the above-described WFMAD. FIG. 16A shows a configuration that includes the workflow-execution engine and development environment 1602, a cloud-computing facility 1604, and the infrastructure-management-and-administration facility 1606 of the above-described WFMAD. Data and information exchanges between components are illustrated with arrows, such as arrow 1608, labeled with port numbers indicating inbound and outbound ports used for data and information exchanges. FIG. 16B provides a table of servers, the services provided by the server, and the inbound and outbound ports associated with the server. Table 16C indicates the ports balanced by various load balancers shown in the configuration illustrated in FIG. 16A. It can be easily ascertained from FIGS. 16A-C that the WFMAD is a complex, multi-virtual-appliance/virtual-server system that executes on many different physical devices of a physical cloud-computing facility.

FIGS. 16D-F illustrate the logical organization of users and user roles with respect to the infrastructure-management-and-administration facility of the WFMAD (1114 in FIG. 11). FIG. 16D shows a single-tenant configuration, FIG. 16E shows a multi-tenant configuration with a single default-tenant infrastructure configuration, and FIG. 16F shows a multi-tenant configuration with a multi-tenant infrastructure configuration. A tenant is an organizational unit, such as a business unit in an enterprise or company that subscribes to cloud services from a service provider. When the infrastructure-management-and-administration facility is initially deployed within a cloud-computing facility or cloud-computing-facility aggregation, a default tenant is initially configured by a system administrator. The system administrator designates a tenant administrator for the default tenant as well as an identity store, such as an active-directory server, to provide authentication for tenant users, including the tenant administrator. The tenant administrator can then designate additional identity stores and assign roles to users or groups of the tenant, including business groups, which are sets of users that correspond to a department or other organizational unit within the organization corresponding to the tenant. Business groups are, in turn, associated with a catalog of services and infrastructure resources. Users and groups of users can be assigned to business groups. The business groups, identity stores, and tenant administrator are all associated with a tenant configuration. A tenant is also associated with a system and infrastructure configuration. The system and infrastructure configuration includes a system administrator and an infrastructure fabric that represents the virtual and physical computational resources allocated to the tenant and available for provisioning to users. The infrastructure fabric can be partitioned into fabric groups, each managed by a fabric administrator. The infrastructure fabric is managed by an infrastructure-as-a-service (“IAAS”) administrator. Fabric-group computational resources can be allocated to business groups by using reservations.

FIG. 16D shows a single-tenant configuration for an infrastructure-management-and-administration facility deployment within a cloud-computing facility or cloud-computing-facility aggregation. The configuration includes a tenant configuration 1620 and a system and infrastructure configuration 1622. The tenant configuration 1620 includes a tenant administrator 1624 and several business groups 1626-1627, each associated with a business-group manager 1628-1629, respectively. The system and infrastructure configuration 1622 includes a system administrator 1630, an infrastructure fabric 1632 managed by an IAAS administrator 1633, and three fabric groups 1635-1637, each managed by a fabric administrator 1638-1640, respectively. The computational resources represented by the fabric groups are allocated to business groups by a reservation system, as indicated by the lines between business groups and reservation blocks, such as line 1642 between reservation block 1643 associated with fabric group 1637 and the business group 1626.

FIG. 16E shows a multi-tenant single-tenant-system-and-infrastructure-configuration deployment for an infrastructure-management-and-administration facility of the WFMAD. In this configuration, there are three different tenant organizations, each associated with a tenant configuration 1646-1648. Thus, following configuration of a default tenant, a system administrator creates additional tenants for different organizations that together share the computational resources of a cloud-computing facility or cloud-computing-facility aggregation. In general, the computational resources are partitioned among the tenants so that the computational resources allocated to any particular tenant are segregated from and inaccessible to the other tenants. In the configuration shown in FIG. 16E, there is a single default-tenant system and infrastructure configuration 1650, as in the previously discussed configuration shown in FIG. 16D.

FIG. 16F shows a multi-tenant configuration in which each tenant manages its own infrastructure fabric. As in the configuration shown in FIG. 16E, there are three different tenants 1654-1656 in the configuration shown in FIG. 16F. However, each tenant is associated with its own fabric group 1658-1660, respectively, and each tenant is also associated with an infrastructure-fabric IAAS administrator 1662-1664, respectively. A default-tenant system configuration 1666 is associated with a system administrator 1668 who administers the infrastructure fabric, as a whole.

System administrators, as mentioned above, generally install the WFMAD within a cloud-computing facility or cloud-computing-facility aggregation, create tenants, manage system-wide configuration, and are generally responsible for insuring availability of WFMAD services to users, in general. IAAS administrators create fabric groups, configure virtualization proxy agents, and manage cloud service accounts, physical machines, and storage devices. Fabric administrators manage physical machines and computational resources for their associated fabric groups as well as reservations and reservation policies through which the resources are allocated to business groups. Tenant administrators configure and manage tenants on behalf of organizations. They manage users and groups within the tenant organization, track resource usage, and may initiate reclamation of provisioned resources. Service architects create blueprints for items stored in user service catalogs which represent services and resources that can be provisioned to users. The infrastructure-management-and-administration facility defines many additional roles for various administrators and users to manage provision of services and resources to users of cloud-computing facilities and cloud-computing facility aggregations.

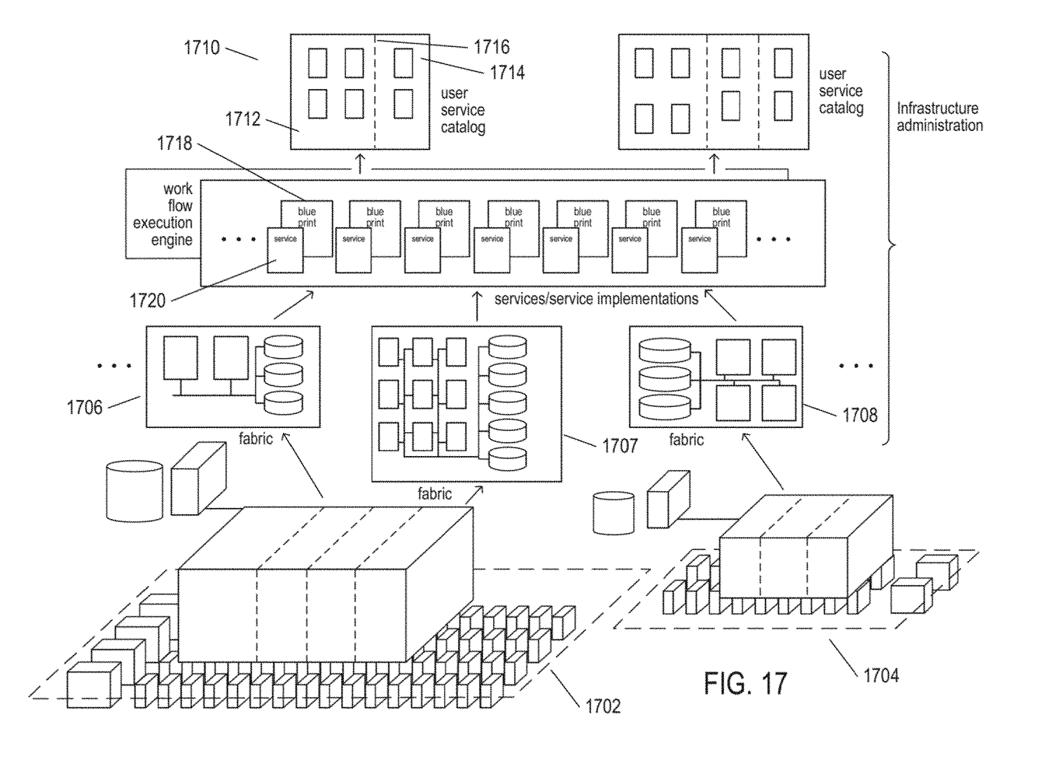

FIG. 17 illustrates the logical components of the infrastructure-management-and-administration facility (1114 in FIG. 11) of the WFMAD. As discussed above, the WFMAD is implemented within, and provides a management and development interface to, one or more cloud-computing facilities 1702 and 1704. The computational resources provided by the cloud-computing facilities, generally in the form of virtual servers, virtual storage devices, and virtual networks, are logically partitioned into fabrics 1706-1708. Computational resources are provisioned from fabrics to users. For example, a user may request one or more virtual machines running particular applications. The request is serviced by allocating the virtual machines from a particular fabric on behalf of the user. The services, including computational resources and workflow-implemented tasks, which a user may request provisioning of, are stored in a user service catalog, such as user service catalog 1710, that is associated with particular business groups and tenants. In FIG. 17, the items within a user service catalog are internally partitioned into categories, such as the two categories 1712 and 1714 and separated logically by vertical dashed line 1716. User access to catalog items is controlled by entitlements specific to business groups. Business group managers create entitlements that specify which users and groups within the business group can access particular catalog items. The catalog items are specified by service-architect-developed blueprints, such as blueprint 1718 for service 1720. The blueprint is a specification for a computational resource or task-service and the service itself is implemented by a workflow that is executed by the workflow-execution engine on behalf of a user.

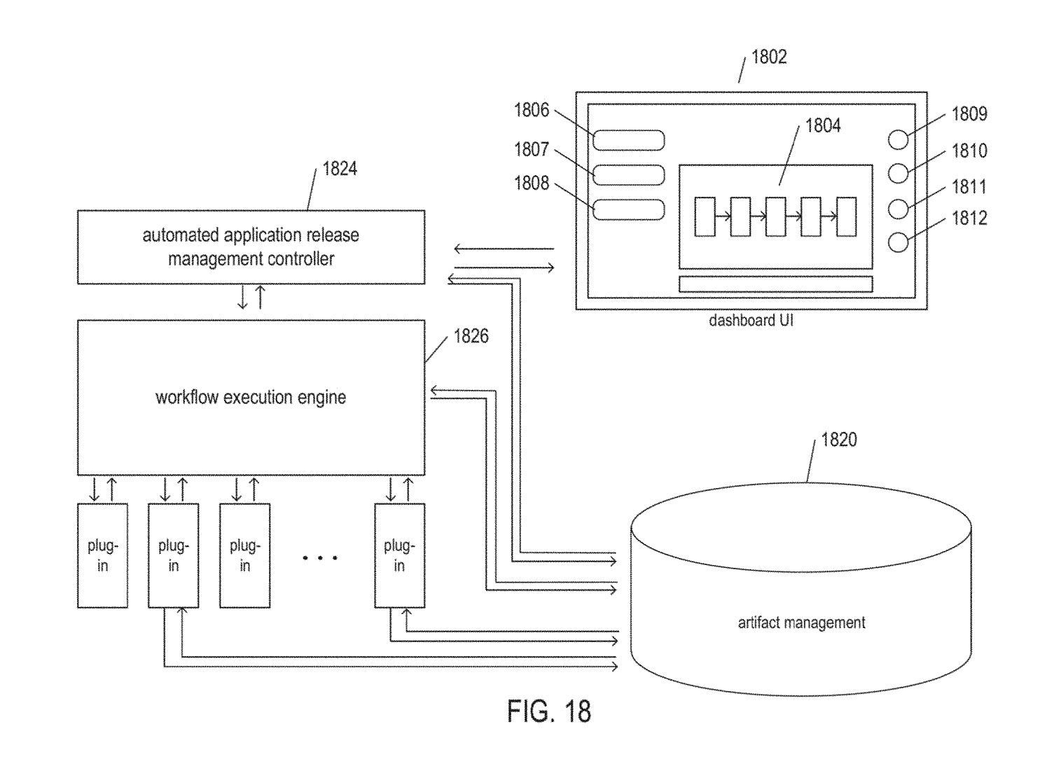

FIGS. 18-20B provide a high-level illustration of the architecture and operation of the automated-application-release-management facility (1116 in FIG. 11) of the WFMAD. The application-release management process involves storing, logically organizing, and accessing a variety of different types of binary files and other files that represent executable programs and various types of data that are assembled into complete applications that are released to users for running on virtual servers within cloud-computing facilities. Previously, releases of new version of applications may have occurred over relatively long time intervals, such as biannually, yearly, or at even longer intervals. Minor versions were released at shorter intervals. However, more recently, automated application-release management has provided for continuous release at relatively short intervals in order to provide new and improved functionality to clients as quickly and efficiently as possible.

FIG. 18 shows main components of the automated-application-release-management facility (1116 in FIG. 11). The automated-application-release-management component provides a dashboard user interface 1802 to allow release managers and administrators to launch release pipelines and monitor their progress. The dashboard may visually display a graphically represented pipeline 1804 and provide various input features 1806-1812 to allow a release manager or administrator to view particular details about an executing pipeline, create and edit pipelines, launch pipelines, and generally manage and monitor the entire application-release process. The various binary files and other types of information needed to build and test applications are stored in an artifact-management component 1820. An automated-application-release-management controller 1824 sequentially initiates execution of various workflows that together implement a release pipeline and serves as an intermediary between the dashboard user interface 1802 and the workflow-execution engine 1826.

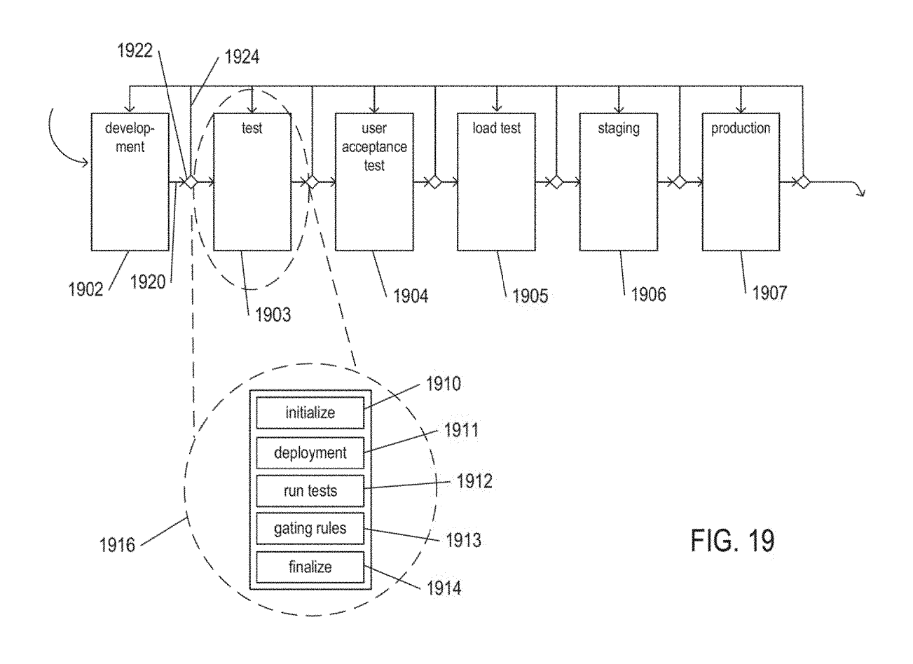

FIG. 19 illustrates a release pipeline. The release pipeline is a sequence of stages 1902-1907 that each comprises a number of sequentially executed tasks, such as the tasks 1910-1914 shown in inset 1916 that together compose stage 1903. In general, each stage is associated with gating rules that are executed to determine whether or not execution of the pipeline can advance to a next, successive stage. Thus, in FIG. 19, each stage is shown with an output arrow, such as output arrow 1920, that leads to a conditional step, such as conditional step 1922, representing the gating rules. When, as a result of execution of tasks within the stage, application of the gating rules to the results of the execution of the tasks indicates that execution should advance to a next stage, then any final tasks associated with the currently executing stage are completed and pipeline execution advances to a next stage. Otherwise, as indicated by the vertical lines emanating from the conditional steps, such as vertical line 1924 emanating from conditional step 1922, pipeline execution may return to re-execute the current stage or a previous stage, often after developers have supplied corrected binaries, missing data, or taken other steps to allow pipeline execution to advance.

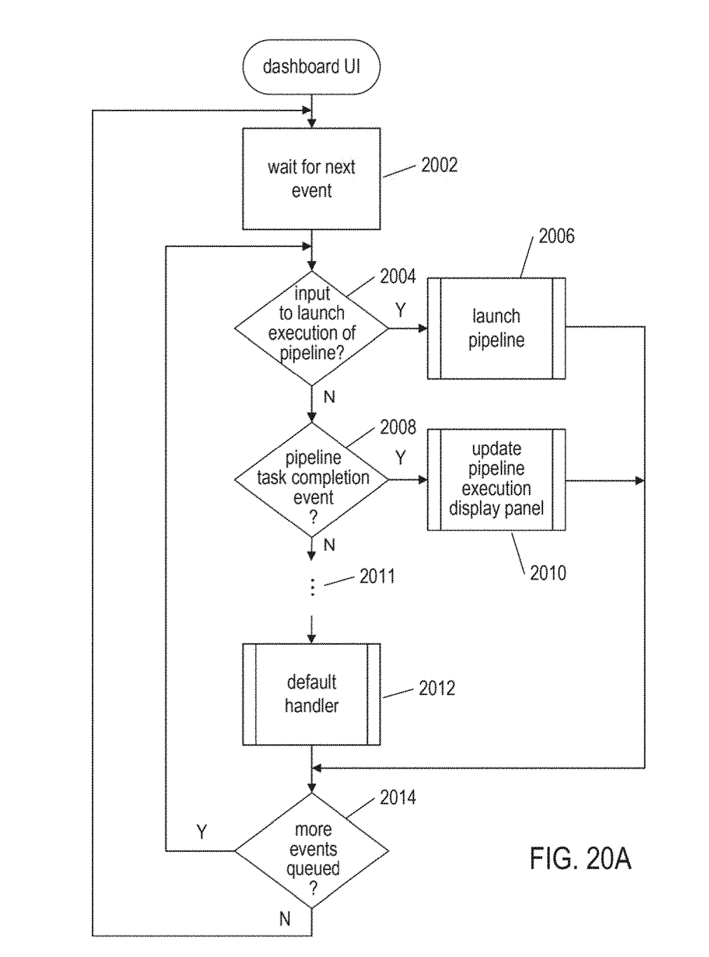

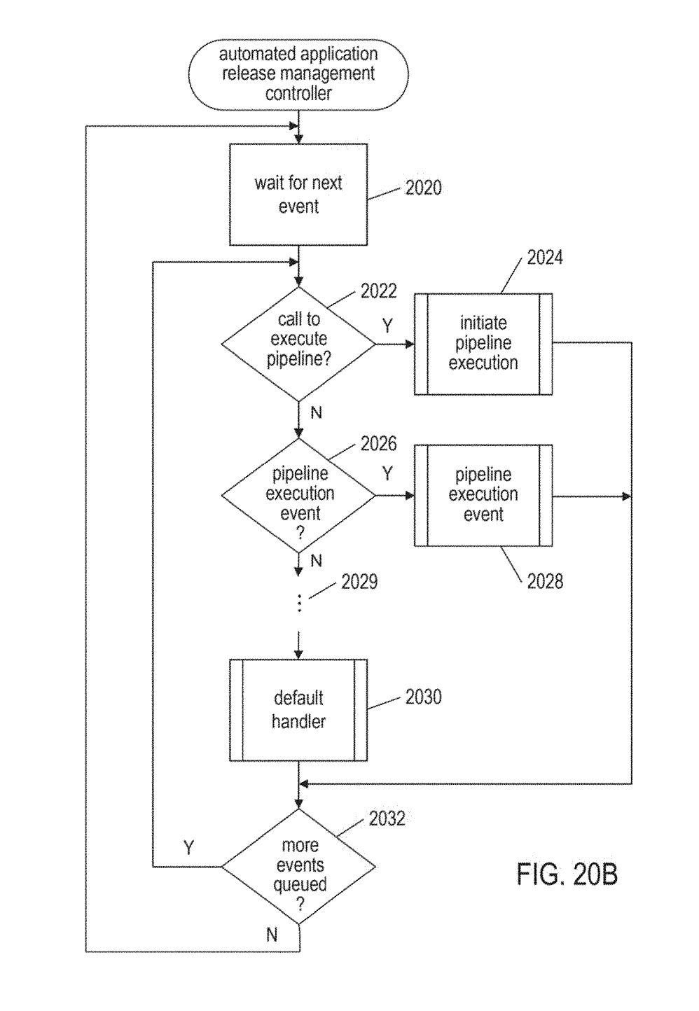

FIGS. 20A-B provide control-flow diagrams that indicate the general nature of dashboard and automated-application-release-management-controller operation. FIG. 20A shows a partial control-flow diagram for the dashboard user interface. In step 2002, the dashboard user interface waits for a next event to occur. When the next occurring event is input, by a release manager, to the dashboard to direct launching of an execution pipeline, as determined in step 2004, then the dashboard calls a launch-pipeline routine 2006 to interact with the automated-application-release-management controller to initiate pipeline execution. When the next-occurring event is reception of a pipeline task-completion event generated by the automated-application-release-management controller, as determined in step 2008, then the dashboard updates the pipeline-execution display panel within the user interface via a call to the routine “update pipeline execution display panel” in step 2010. There are many other events that the dashboard responds to, as represented by ellipses 2011, including many additional types of user input and many additional types of events generated by the automated-application-release-management controller that the dashboard responds to by altering the displayed user interface. A default handler 2012 handles rare or unexpected events. When there are more events queued for processing by the dashboard, as determined in step 2014, then control returns to step 2004. Otherwise, control returns to step 2002 where the dashboard waits for another event to occur.

FIG. 20B shows a partial control-flow diagram for the automated application-release-management controller. The control-flow diagram represents an event loop, similar to the event loop described above with reference to FIG. 20A. In step 2020, the automated application-release-management controller waits for a next event to occur. When the event is a call from the dashboard user interface to execute a pipeline, as determined in step 2022, then a routine is called, in step 2024, to initiate pipeline execution via the workflow-execution engine. When the next-occurring event is a pipeline-execution event generated by a workflow, as determined in step 2026, then a pipeline-execution-event routine is called in step 2028 to inform the dashboard of a status change in pipeline execution as well as to coordinate next steps for execution by the workflow-execution engine. Ellipses 2029 represent the many additional types of events that are handled by the event loop. A default handler 2030 handles rare and unexpected events. When there are more events queued for handling, as determined in step 2032, control returns to step 2022. Otherwise, control returns to step 2020 where the automated application-release-management controller waits for a next event to occur.

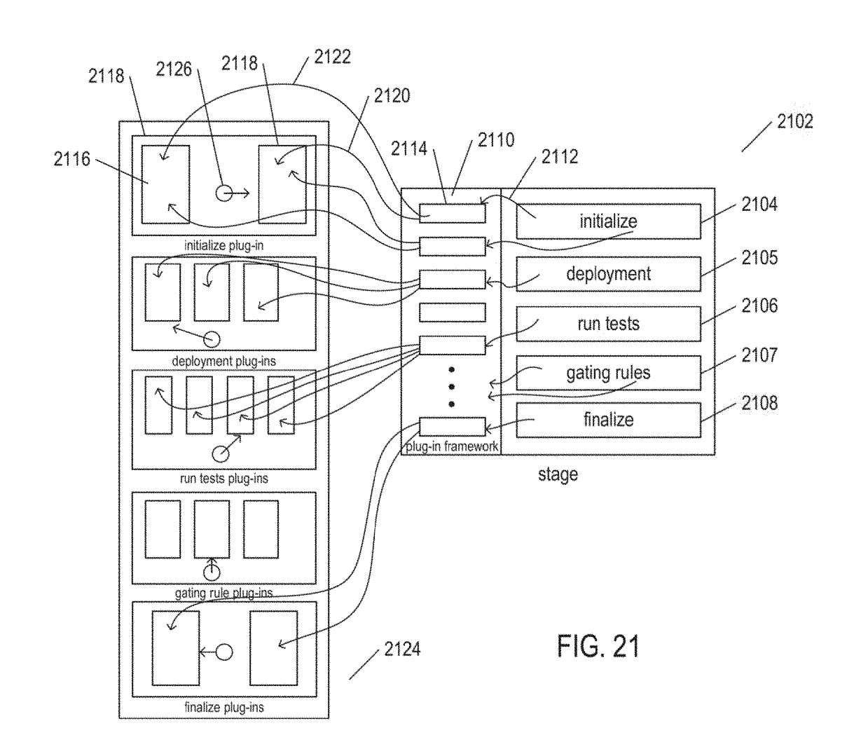

FIG. 21 illustrates additional details with respect to particular type of application-release-management-pipeline stage that is used in pipelines executed by a particular class of implementations of the automated application-release-management subsystem. The application-release-management-pipeline stage 2102 shown in FIG. 21 includes the initialize 2104, deployment 2105, run tests 2106, gating rules 2107, and finalize 2108 tasks discussed above with respect to the application-release-management-pipeline stage shown in inset 1916 of FIG. 19. In addition, the application-release-management-pipeline stage 2102 includes a plug-in framework 2110 that represents one component of a highly modularized implementation of an automated application-release-management subsystem.

The various tasks 2107-2108 in the pipeline stage 2102 are specified as workflows that are executed by a work-flow execution engine, as discussed above with reference to FIGS. 18-20B. In the currently described implementation, these tasks include REST entrypoints which represent positions within the workflows at each of which the workflow execution engine makes a callback to the automated application-release-management subsystem. The callbacks are mapped to function and routine calls represented by entries in the plug-in framework 2110. For example, the initialized task 2104 includes a REST endpoint that is mapped, as indicated by curved arrow 2112, to entry 2114 in the plug-in framework, which represents a particular function or routine that is implemented by one or more external modules or subsystems interconnected with the automated application-release-management subsystem via plug-in technology. These plug-in-framework entries, such as entry 2114, are mapped to corresponding routine and function calls supported by each of one or more plugged-in modules or subsystems. In the example shown in FIG. 21, entry 2114 within the plug-in framework that represents a particular function or routine called within the initialized task is mapped to a corresponding routine or function in each of two plugged-in modules or subsystems 2116 and 2118 within a set of plugged-in modules or subsystems 2118 that support REST entrypoints in the initialized task, as represented in FIG. 21 by curved arrows 2120 and 2122. During pipeline execution, callbacks to REST entrypoints in tasks within application-release-management pipelines are processed by calling the external routines and functions to which the REST entrypoints are mapped. Tasks within a stage may be executed sequentially or, in many implementations, may be executed in parallel, when dependencies between tasks do not constrain parallel execution.

Each stage in an application-release-management pipeline includes a stage-specific plug-in framework, such as the plug-in framework 2110 for stage 2102. The automated application-release-management subsystem within which the stages and pipelines are created and executed is associated with a set of sets of plugged-in modules and subsystems, such as the set of sets of plugged-in modules and subsystems 2124 shown in FIG. 21. A cloud-computing facility administrator or manager, when installing a workflow-based cloud-management system that incorporates the automated application-release-management subsystem or reconfiguring the workflow-based cloud-management system may, during the installation or reconfiguration process, choose which of the various plugged-in modules and subsystems should be used for executing application-release-management pipelines. Thus, the small selection features, such as selection feature 2126 shown within the set of sets of plugged-in modules and subsystems 2124, indicates that, in many cases, one of the multiple different plugged-in modules or subsystems may be selected for executing application-release-management-pipeline tasks. This architecture enables a cloud-computing-facility administrator or manager to select particular external modules to carry out tasks within pipeline stages and to easily change out, and substitute for, particular plugged-in modules and subsystems without reinstalling the workflow-based cloud-management system or the automated application-release-management subsystem. Furthermore, the automated application-release-management subsystem is implemented to interface to both any currently available external modules and subsystems as well as to external modules and subsystems that may become available at future points in time.

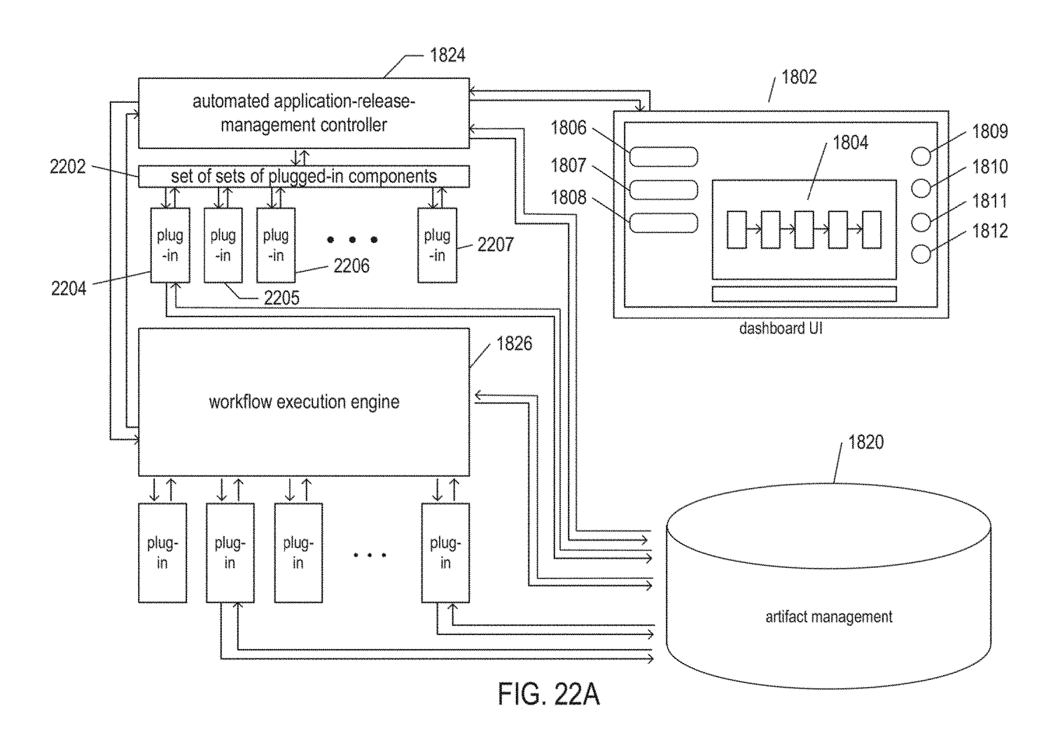

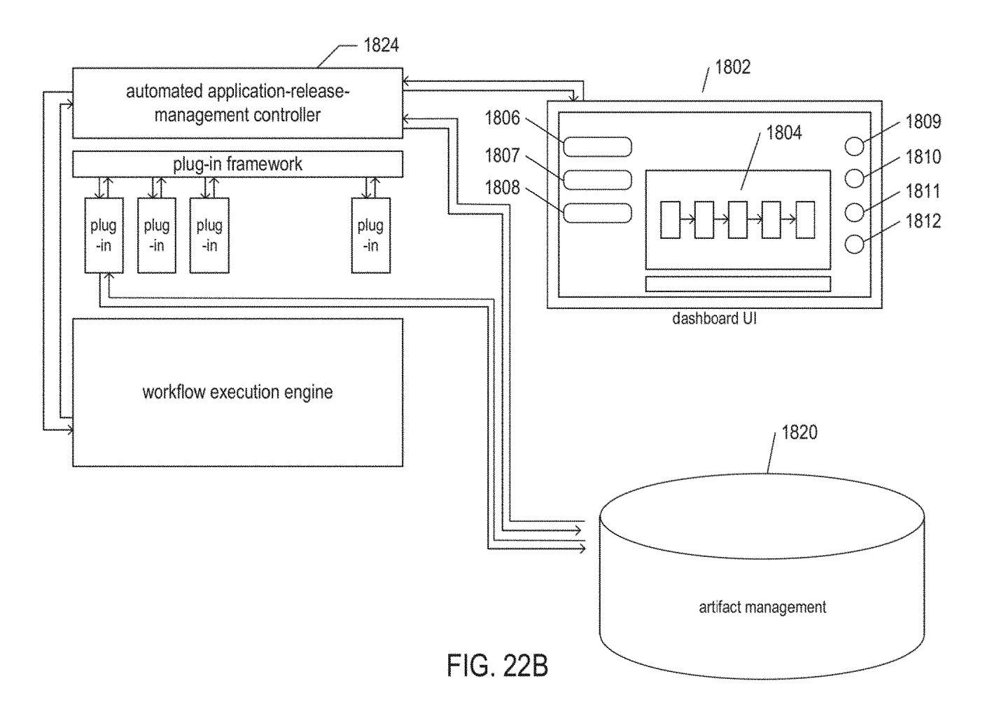

FIGS. 22A-B illustrate a more modularized automated application-release-management subsystem using illustration conventions similar to those used in FIG. 18. The components previously shown in FIG. 18 are labeled with the same numeric labels in FIG. 22A as in FIG. 18. As shown in FIG. 22A, the automated application-release-management controller 1824 includes or interfaces to the set of sets of plugged-in modules and subsystems 2202, discussed above as set of sets 2124 in FIG. 21. This set of sets of plugged-in modules and subsystems provides a flexible interface between the automated application-release-management controller 1824 and the various plugged-in modules and subsystems 2204-2207 that provide implementations of a variety of the REST entrypoints included in task workflows within pipeline stages. The modularized automated application-release-management subsystem thus provides significantly greater flexibility with respect to external modules and subsystems that can be plugged in to the automated application-release-management subsystem in order to implement automated application-release-management-subsystem functionality.

As shown in FIG. 22B, the modularized automated-application-release-management subsystem additionally allows for the replacement of the workflow execution engine (1826 in FIG. 22A) initially bundled within the workflow-based cloud-management system, discussed above with reference to FIG. 11, by any of alternative, currently available workflow execution engines or by a workflow execution engine specifically implemented to execute workflows that implement application-release-management-pipeline tasks and stages. Thus, as shown in FIG. 22B, a different workflow execution engine 2220 has been substituted for the original workflow execution engine 1826 in FIG. 22A used by the automated application-release-management subsystem to execute pipeline workflows. In essence, the workflow execution engine becomes another modular component that may be easily interchanged with other, similar components for particular automated-application-release-management-subsystem installations.

Implementations of the Current Disclosed Persona-Based Dashboard

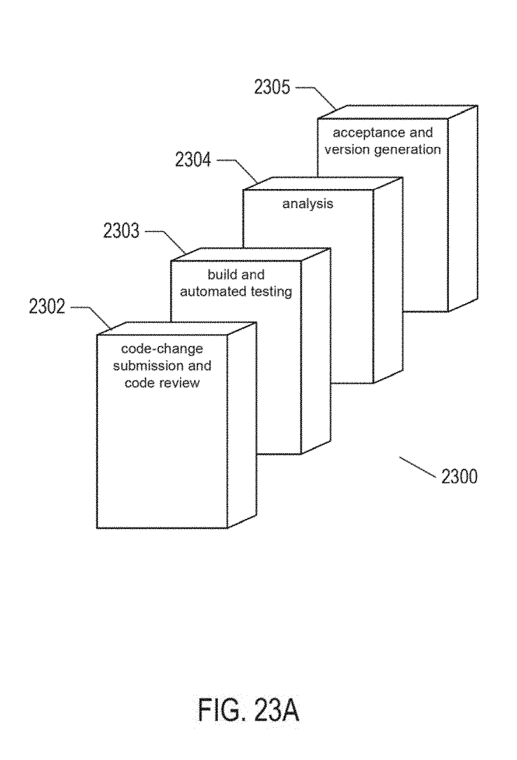

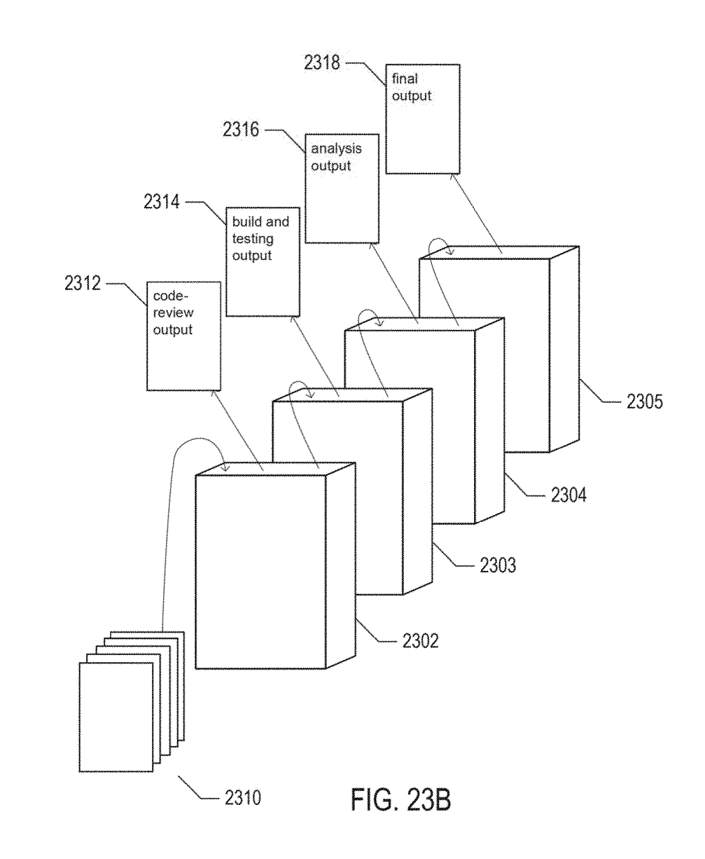

FIG. 23A alternatively illustrates a simple application-release-management pipeline. The application-release-management pipeline 2300 includes, in this example, four stages 2302-2305. The first stage 2302 receives code-change submissions with respect to an application managed by an automated application-release-management subsystem and undertakes an initial code review of the submitted code changes by development-team members. The second stage 2303 builds a new, test version of the application that incorporates the code changes and carries out automated testing of the new, test version of the application. The third stage 2304 analyzes the results of automated testing and may carry out various types of static analysis of the application code and other types of analysis. The final stage 2305 carries out code-change acceptance and incorporation of the code change into a release version of the application. Of course, this example simplifies the application-release-management pipeline and processes carried out by an automated application-release-management subsystem. An automated application-release-management subsystem generally receives additional types of requests and provides additional corresponding services, in addition to code-change processing. However, the application-release-management pipeline is a reasonable context in which to describe the persona-based-dashboard feature of the automated application-release-management subsystem to which the current application is directed.

FIG. 23B illustrates the processes carried out by the application-release-management pipeline illustrated in FIG. 23A. A code change 2310 is submitted by a developer to the first stage 2302, which receives the code change, generates internal descriptive information for the code change, and carries out a code review by requesting reviews from members of the developer's development team. When the code review is complete, the first stage outputs a code-review report 2312, or output data, that is reviewed by the developer, through a dashboard provided to the developer, by opening and reading a document, or by other methods, to facilitate subsequent steps in the code-change process. In many cases, the developer modifies the initially submitted code change, in accordance with the output code-review report, and resubmits the code change. Ultimately, when the code change passes the review stage, the code change passes to the second stage 2303, where a test version of the application is built and automatically tested. Following automated testing, the second stage 2303 outputs a build-and-testing report 2314 or output data. Again, depending on the testing results, the developer may again modify the code change and resubmit the code change to the application-release-management pipeline, or the code change may pass to the third stage 2304, where the testing results are carefully analyzed and additional types of code analysis are undertaken. The third stage 2304 outputs an analysis report or other output data 2316. Again, the developer may either elect to modify the code change, in view of the analysis report, or may allow the code change to progress to the fourth stage 2305, where the code change is incorporated into a new application version that is released by the automated application-release-management subsystem, with a final report generated 2318 and displayed to the user through a dashboard rendered to the user by the automated application-release-management subsystem, through a document-display utility, or in other ways. Of course, the data included in the output reports may be viewed by other users of the automated application-management-release system, including the developer's manager, various other members of the developer's development team, release engineers, project managers, and application-release-management administrators. Additionally, the data included in in the output reports is generally persistently stored, for some period of time, and remains available for subsequent types of reports and displays, including printed reports and reports incorporated into documents accessible through various types of document-presentation facilities.

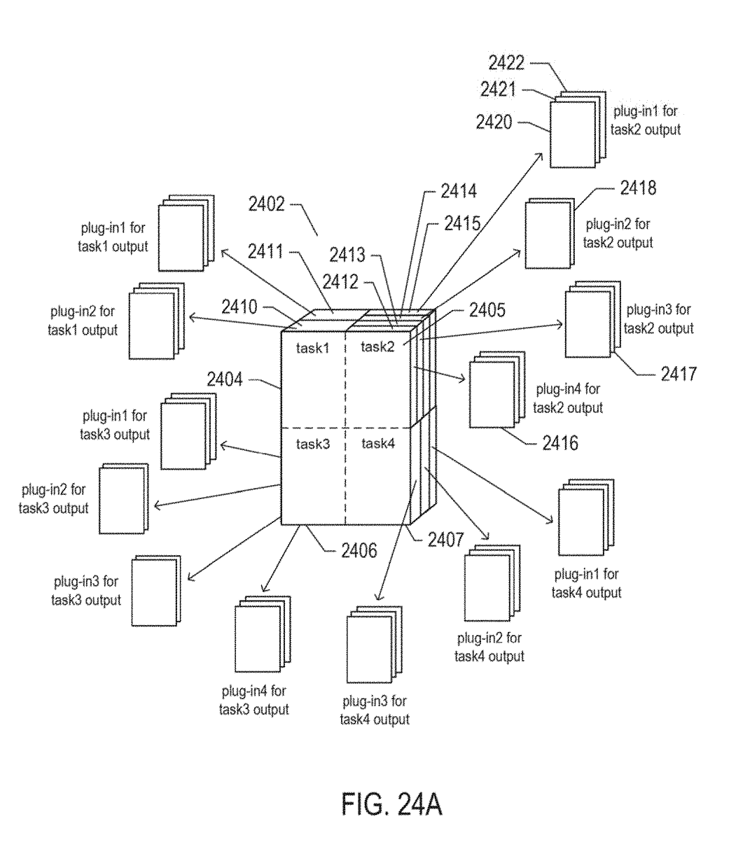

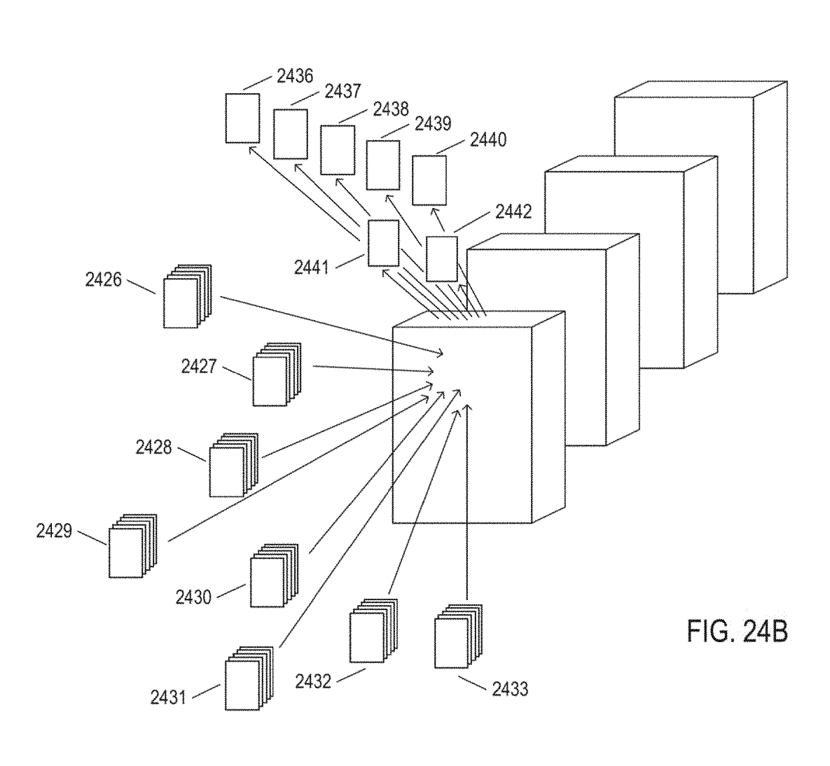

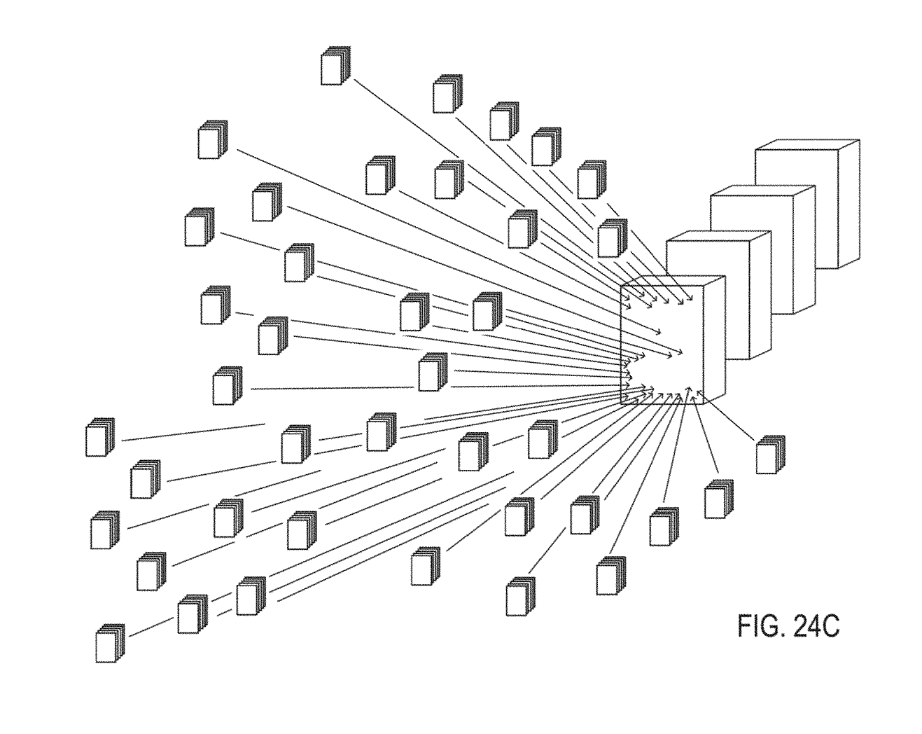

FIGS. 24A-C illustrate certain problems associated with data output by the automated application-release-management subsystem. In FIG. 24A, one stage 2402 of the application-release-management pipeline is illustrated. This stage includes three tasks 2404-2407. Each task can be carried out by two or more task implementations, represented in FIG. 24A by layers, such as the two layers 2410 and 2411 that together compose the task implementations available to the application-release-management pipeline for carrying out task 2404. There are four different implementations 2412-2415 for task 2405. Each of the different implementations for a task may use different plug-in components that represent different locally implemented executables or third-party executables. Unfortunately, it is often the case that each different task implementation produces a different type of output for the task. As shown in FIG. 24A, for example, each of the four different implementations 2412-2415 for task 2405 outputs a different type of report, or output data 2416-2419. In addition, each different executable or implementation may produce a variety of different report versions, such as versions 2420-2422 of output-report type 2419 produced by implementation 2415 of task 2405. As a result, as illustrated in FIG. 24A, the data output by the illustrated stage 2402 may have any of a large number of different formats, organizations, and content selected from the large number of possible combinations of the different output-report formats, organizations, and content. This large number of different possible outputs creates significant problems for an output-display feature, such as the dashboard provided to a user of the automated application-release-management subsystem. Identifying, locating, and retrieving particular data items may be difficult, for example, and even finding the data related to a particular task or stage execution may be computationally burdensome and involve significant development time and costs.

As shown in FIG. 24B, an additional problem associated with data output by the stages of the application-release-management pipeline is the fact that many different code changes 2426-2433 may be processed over a given time interval by the automated application-release-management subsystem, often concurrently, resulting in output of a corresponding large number of reports 2436-2442 or other data. There is a potentially enormous volume of data output by each stage of multiple instances of the automated-root release-management-pipeline during relatively short periods of time. As shown in FIG. 24C, when all of the code changes submitted for all of the applications being managed by many instances of the application-release-management pipeline within the automated application-release-management subsystem is considered, the volumes of output data may be truly large.

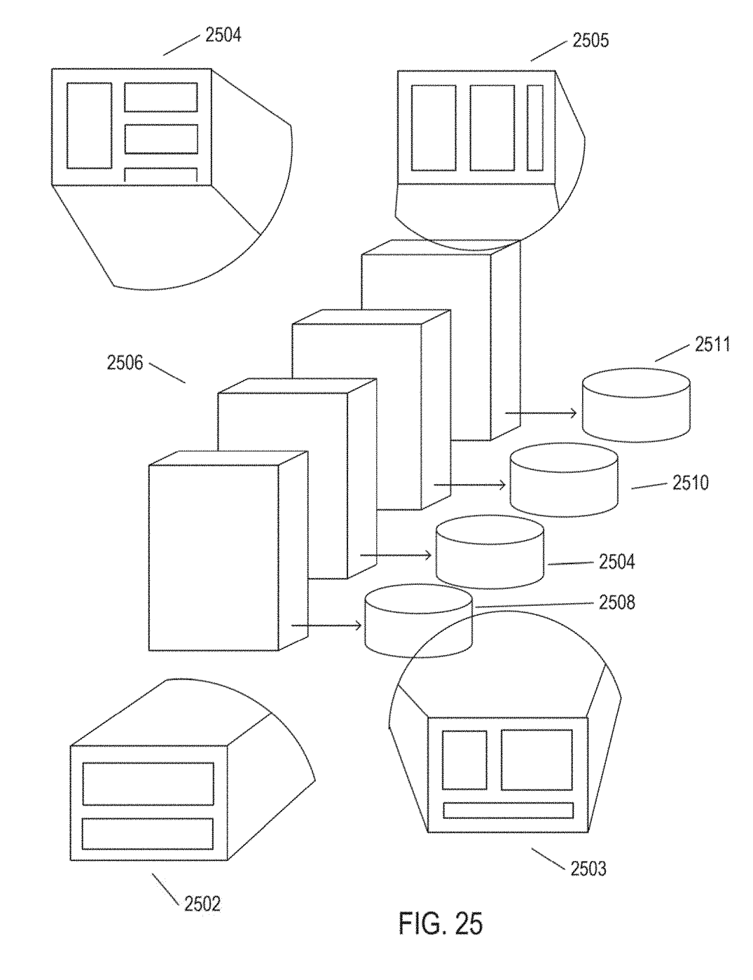

FIG. 25 illustrates different types of dashboard interfaces to different types of users of the automated application-release-management subsystem. As shown in FIG. 25, each different type of dashboard 2502-2505 represents a different view of the automated-application-release-management system 2506 and the voluminous amounts of data 2508-2511 output from the automated application-release-management subsystem. For example, the dashboard displayed to an application developer 2502 may include display features that display information related to on-going and completed code reviews, application builds in which the developers code changes are incorporated, and messages generated by the automated application-release-management subsystem as well as by other users of the application-release-management system, including members of the developer's development team. By contrast, the dashboard displayed to a release engineer 2503 may display aggregated data for large numbers of completed tasks related to a particular application or, in some cases, to all applications managed by the automated application-release-management subsystem. Whereas the application developer is concerned with the application code that he or she develops and submits as code changes, the release engineer may be more concerned with aggregate information compiled over many different developers and many different applications. The dashboard displayed to a project manager 2504 may include various information aggregated and compiled for tasks carried out by members of the project-manager's project teams, and may differ significantly from the types of dashboards displayed to release engineers and application developers. However, because of the problems discussed above with reference to FIGS. 24A-C, sorting through, identifying, and rendering the types of data significant for different individuals and different classes of individuals can be at least imposing and is often computationally intractable. However, when information output from the automated application-release-management subsystem is simply dumped through a dashboard interface to users without considering the users' needs and viewpoints, the dashboard displays generally become useless and annoying, since the entire burden of searching for, and identifying, relevant information falls to users who often lack the time and understanding of the many different types of output data to assemble data relevant to the jobs that they perform.

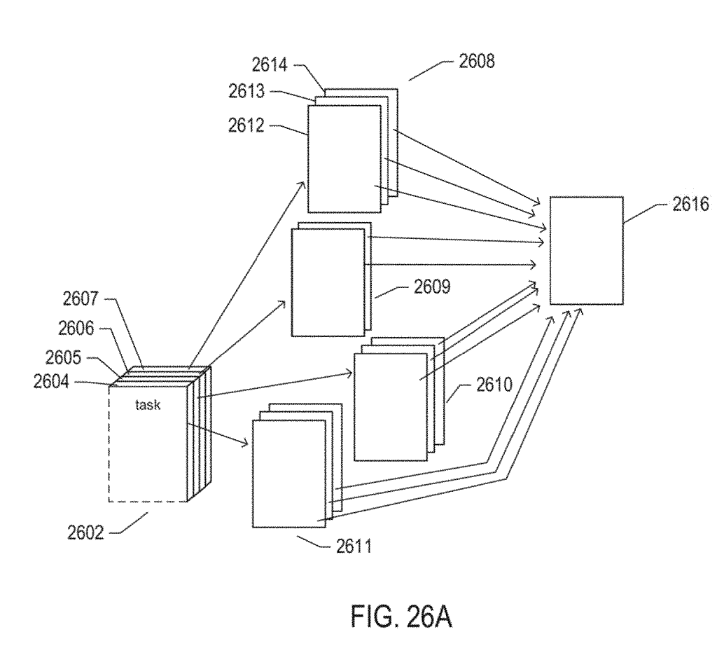

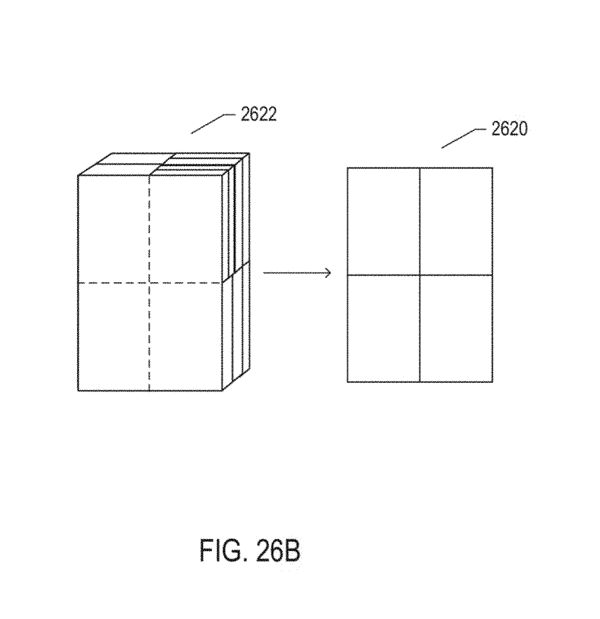

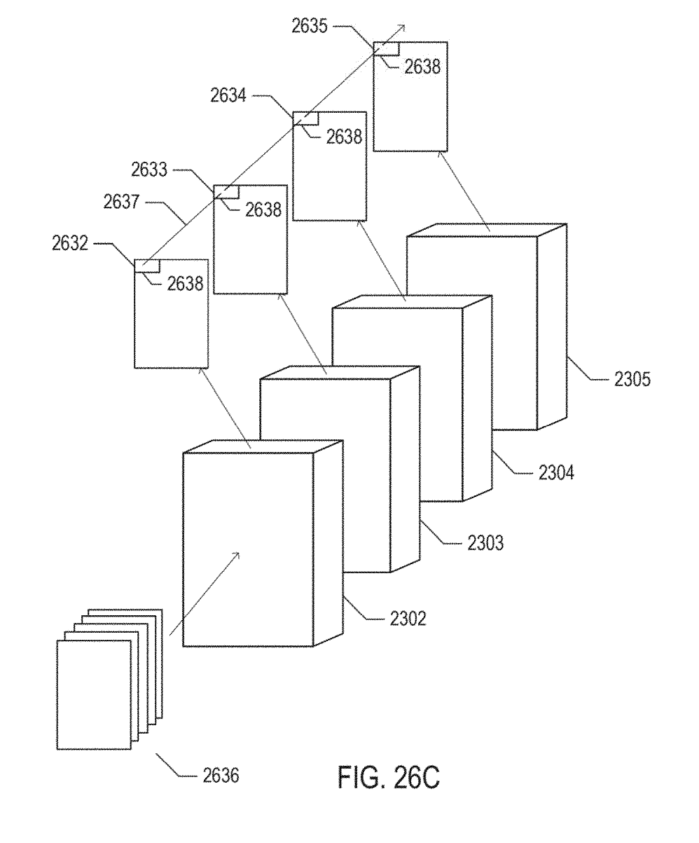

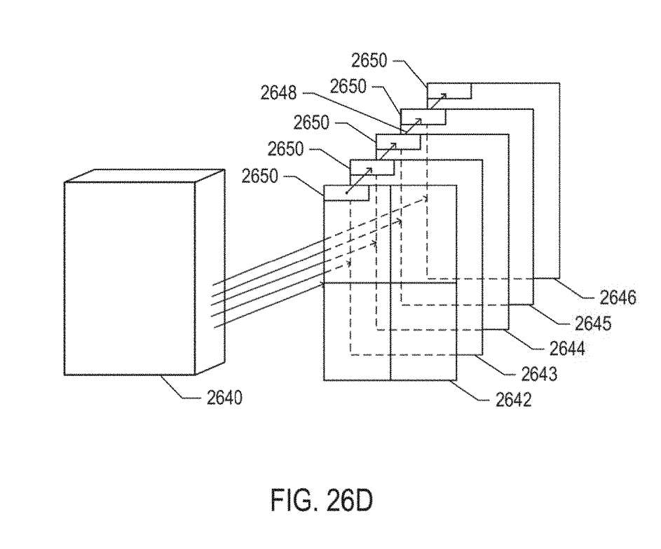

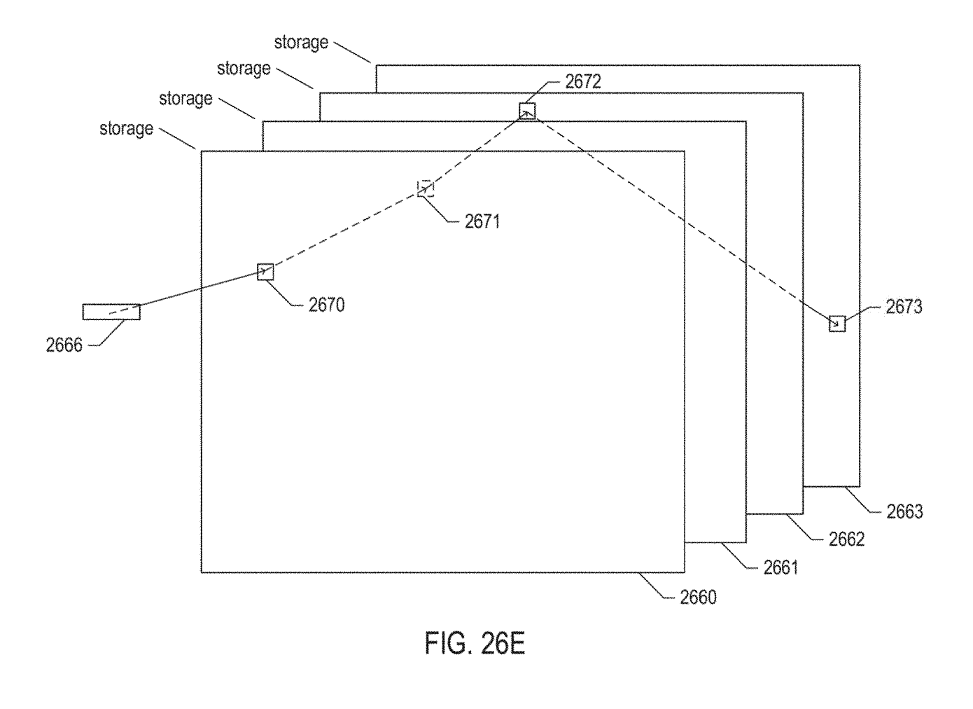

FIGS. 26A-E illustrate various approaches used to construct persona-based dashboard displays that address certain of the problems associated with the types and quantities of data output by an automated application-release-management subsystem. FIG. 26A illustrates standardization of task output. As previously shown in FIG. 24A, an automated application-release-management subsystem often includes tasks 2602 that have multiple implementations 2604-2607 that each outputs a different type of output data or output report 2608-2611, and often output different versions of the different types of output data or output report, such as versions 2612-2614 of output-report type 2608. The differences between the different styles and types of output data may include differences in the organization of the data, differences in the types of data that are generated, differences in the data types for particular data items, and other such differences. As a result, it is difficult for an automated process, such as an automated information-rendering process that generates information for display on dashboards, to identify particular information items in the various different types of output data and to collect meaningful subsets of the output data to display to particular users. To address this problem, the currently disclosed automated application-release-management subsystem standardizes the data output of each task, so that instead of many different types and versions of output data 2608-2611 and 2612-2614, each executable that carries out a particular task produces a single standard data output 2616. There are many ways to accomplish standardize data output. One way is to publish a template for the data output and require that all executables for a particular task produce output according to the published template, or standard. Another approach is to require that executables that implement a particular task include an output-translation method that translates native output from the executable to the standardized output specified by the published template. Yet another approach is for the automated-application-release-management-system developers to produce mapping modules for each task that map the outputs produced by the various task implementations to the standard output. As shown in FIG. 26B, standardization of task output facilitates standardization of data output 2620 from each stage 2622.

FIG. 26C illustrates a second approach employed by the currently disclosed automated application-release-management subsystem to handle data volume and data organization problems. In this approach, the automated application-release-management subsystem creates contexts within the data output by the application-release-management pipeline. As shown in FIG. 26C using the same illustration conventions as previously used in FIG. 23B, each stage 2302-2305 of the application-release-management pipeline 2630 produces output data or an output report 2632-2635 during the process of receiving and incorporating a code change 2636. The data output by each stage is linked, as indicated by arrow 2637 in FIG. 26C, by a common code-change identifier 2638 that is generated when the code change is first submitted, that follows the code change through the various tasks and stages of the application-release-management pipeline, and that is included in the data output from each stage and task to allow all of the data corresponding to the code change to be easily retrieved and assembled. The data corresponding to a code change is referred to as a data context. As shown in FIG. 26D, a similar stage-level data context is generated for the data output from each stage by including a common stage identifier in the data output from the stage. In FIG. 26D, stage 2640 produces multiple output reports 2642-2646 over a period of time, and all of these output reports are linked together, as represented by arrow 2648, through common stage-identifying information 2650 included in each data set or report output by the stage.

As a result of providing for code-change contexts and stage-level contexts, and as a result of standardizing output from the various different executables that can be used to carry out each task of each stage, the output data from the application-release-management pipeline can be logically accessed via context and stage identifiers. FIG. 26E illustrates context-based output-data access. As shown in FIG. 26E, the output data from an application-release-management pipeline can be viewed as a set of stage planes 2660-2663 that includes the data output by each stage. The data related to a particular code change, or other type of request submitted to the automated application-release-management subsystem, can be easily found using an identifier for the code change 2666 to locate all of the relevant data in the code-change context 2670-2673.

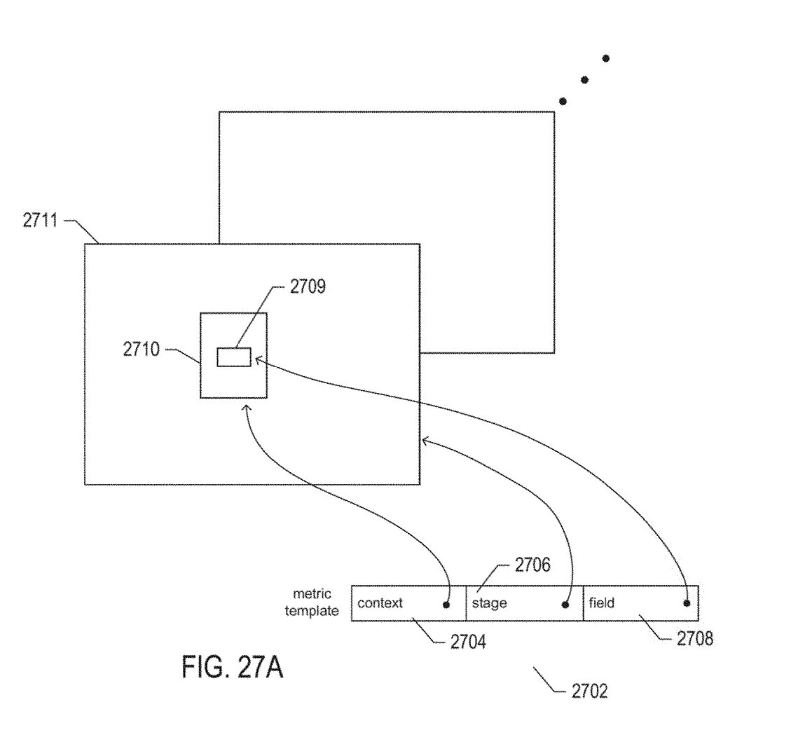

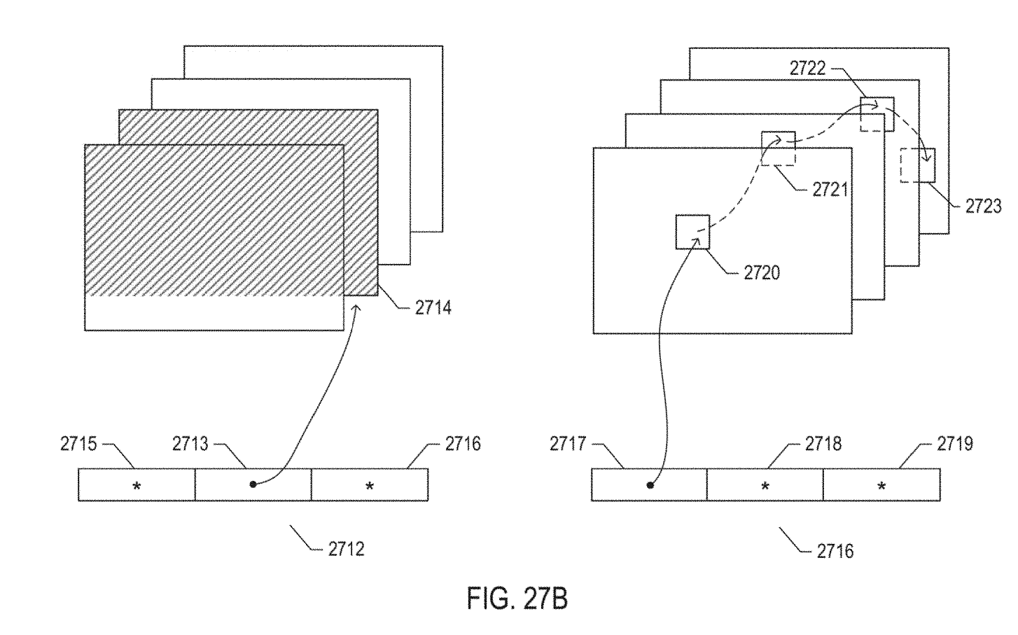

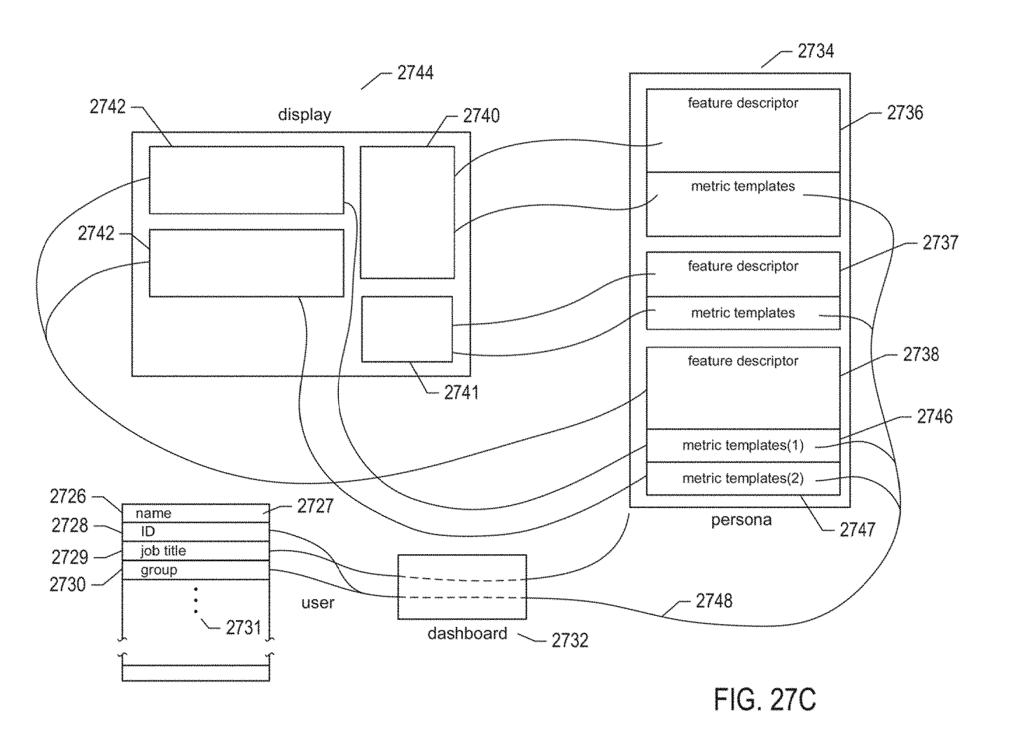

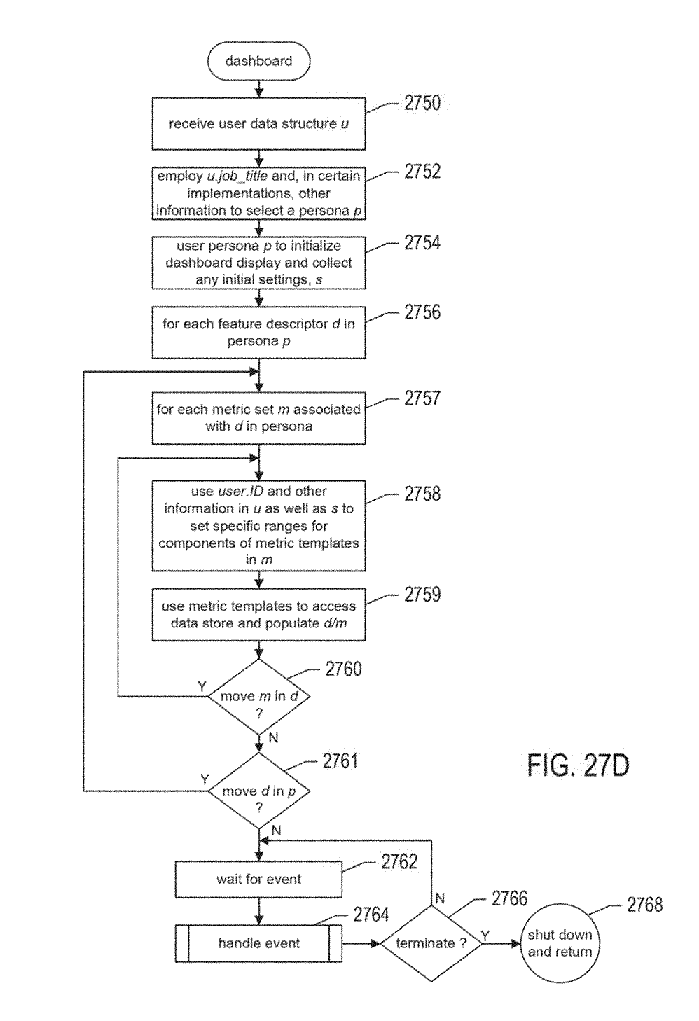

FIGS. 27A-D Illustrate implementation of a persona-based dashboard by an automated application-release-management subsystem. FIG. 27A illustrates a metric template. The metric template 2702 specifies one or more data items in the output data collected and stored by an automated-application-release-management system. The metric template includes a contexts component 2704 that specifies one or more code-change contexts or other submitted-task contexts, a stage component 2706 that specifies one or more stages, and a field component 2708 that specifies one or more data fields in the standardized output from the stage specified by the stage component 2706. In the example of FIG. 27 A, the metric template 2702 includes component values that specify a particular data field 2709 within the data corresponding to a particular context 2710 within the data output by a particular stage 2711. As shown in FIG. 27B, ranges or wildcard values can be included in metric-template components to specify ranges of output data or all of the output data of a particular type. For example, metric template 2712 includes a specification 2713 of a particular stage 2714 but uses while-card entries 2715 and 2716 to specify all code-change contexts and fields, as a result of which metric template 2712 specifies all of the output data in the stage playing 2714. Similarly, metric template 2716 specifies a particular code-change context 2717 but uses wildcards 2718 and 2719 for the stage-component and field-component entries, as a result of which metric template 2716 specifies the output data 2720-2723 for a particular code-change context. Of course, there are many different possible ways of specifying particular data items in particular collections or groups of data items in addition to the above-discussed three-component metric templates. These methods are enabled by the data contexts implemented by including context identifiers and stage identifiers in the output data.

FIG. 27C illustrates persona-based display of data output by an application-release-management pipeline to a particular class of users. Each user is represented, in the illustrated automated-application-release-management-subsystem illustration, by a user data structure 2726. This data structure generally contains alphanumeric representations of the user's name 2727, a user identifier for the user 2728, a job title for the user 2729, and a group to which the user belongs 2730. Ellipses 2731 indicate that many additional fields may be included in the user data structure. The job title 2729 field in the user data structure is used by a dashboard-display component 2732 of the automated application-release-management subsystem to select a persona template 2734 for the user. A persona template specifies the type of dashboard display to be presented to the user by the automated application-release-management subsystem. In the implementation illustrated in FIG. 27C, the persona template 2734 includes specifications of the various different features 2736-2738 that are displayed to the user through the dashboard 2740-2742. Note that there are two instances 2742 of the third type of feature 2738 in the dashboard display 2744. Each feature descriptor in the persona template is accompanied by one or more sets of metric templates that specify the data displayed within the output feature. Feature descriptor 2738 includes two different sets of metric templates 2746 and 2747, indicating that two different instances 2742 of the feature are displayed by the dashboard display 2744 to display two different data sets specified by the 2 different sets of metric templates 2746-2747. The feature descriptors may include descriptive data as well as references to executables that use the associated metric templates to access and retrieve specific output data from the application-release-management pipeline and to render the retrieved output data for display by the executable referenced by the feature descriptor. Features may include text windows, graphs, general charts, and charts that display trends. Persona templates are associated with different job titles, so that the dashboards provided to users of the automated application-release-management subsystem is persona-based. When logged-in as an application developer, a user is presented with an application-developer dashboard display while, when logged-in as a project manager, a user is presented with a project-manager dashboard display. In addition, the dashboard display is also personalized to individual users. In the implementation shown in FIG. 27C, the dashboard-display component 2732 employs the ID 2728 and a group identifier 2734 for the user to include specific values or ranges within certain components of the metric templates, as indicated by branching arrow 2748, to personalize the data displayed by the dashboard display for the particular user. For an application developer, as one example, the dashboard-display component 2732 uses the contents of the ID and group fields 2728 and 2730 in the user data structure 2726 to determine the code-change identifiers related to the application developer and then updates the values of the code-change metric-template components in the metric-template sets associated with the feature descriptors in the application-developer persona template to generate an individualized persona template for the application-developer. Of course, there are many alternative approaches to presenting individualized, persona-based dashboards to users of an automated application-release-management subsystem. These alternative approaches may use the machinery of relational database management systems to generate particular views for particular classes of users, as one example. As one example, data stored for display through persona-based dashboards, in many implementations, is associated with tenant and business-group identifiers so that a persona-based dashboard is additionally tailored to display only data for the tenant and business group with which a user is associated. There are many additional types of data filters and selection rules for selecting data that may be applied to tailor dashboard display to individual users.

FIG. 27D provides a control-flow diagram that illustrates implementation of a persona-based dashboard. In step 2750, the persona-based dashboard receives a user data structure u for a user to which to display data. In step 2752, the persona-based dashboard employs the contents of the job-title field in the user data structure you to select a persona template p for the user. In certain implementations, additional information may be used to determine which persona template to use for the user. In step 2754, the persona-based dashboard uses the selected persona p to initialize the dashboard display and collect any initial user-specified dashboard settings s. Dashboard settings may, for example, specify the time windows for display data, particular features for initial display, and other parameters and characteristics for the dashboard display. In the outer for-loop of steps 2756-2761, each feature descriptor d in the persona template p is considered. In the inner for-loop of steps 2757-2760, each metric-template set m associated with the currently considered feature descriptor d in the persona template p is considered. In step 2758, the persona-based dashboard employs the user's ID and any other pertinent information obtained from the user data structure u, as well as the settings s, to set specific ranges or values for components of the metric templates in the set of metric templates M. In step 2759, the persona-based dashboard uses the metric templates in the metric-template set m in order to use the metric-template set m to access data in an output data store and populate the feature descriptor d. Once the initial display is presented to the user, the persona-based dashboard waits, in step 2762, for a next event. When a next event occurs, the persona-based dashboard calls a handler for the event, in step 2764. When, as a result of handling the event, the persona-based dashboard is directed to terminate, as determined in step 2766, the persona-based dashboard shuts down, in step 2768. Otherwise, control flows back to step 2762, where the persona-based dashboard waits for a next event to occur. The types of events that may occur are generally input events. For example, the user may input data to the dashboard to select display of other types of features, data from other data windows, and make other such changes to the dashboard display.

Although the present invention has been described in terms of particular embodiments, it is not intended that the invention be limited to these embodiments. Modifications within the spirit of the invention will be apparent to those skilled in the art. For example, any of many different design and implementation parameters, including selection of virtualization and operating systems, hardware platforms, modular organization, control structures, data structures, programming languages, and other such design and implementation parameters may be varied in order to produce numerous alternative implementations of the above-described automated application-release-management subsystem. As discussed above, there are many different approaches to select relevant data in addition to using the above-describe three-component metric templates. Data selection can be, for example, specified by relational-database queries. Whatever approaches are used, selection of relevant output data for relevant personas and individuals was facilitated by the data-implemented contexts discussed above with reference to FIGS. 26C-E and by the standardized data outputs from tasks and stages discussed above with reference to FIGS. 26A-B. Similarly, alternative implementations may use different approaches to specify the information displayed 2 different classes of users. An automated application-release-management subsystem may concurrently process many different tasks on behalf of many different users related to many different applications, and may employ the above-discussed methods and implementations to concurrently provide persona-based dashboard to multiple users, each user viewing a particular type of dashboard compatible with the user's job description and individualized for the particular user.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. cm What is claimed is:

1. An automated-application-release-management subsystem within a cloud-computing facility having multiple servers, data-storage devices, and one or more internal networks, the automated-application-release-management subsystem comprising:
a dashboard user interface;
an automated-application-release-management controller;
an interface to a workflow-execution engine within the cloud-computing facility;
an artifact-storage-and-management subsystem; and
a dashboard-display component that displays persona-based dashboards.

2. The automated-application-release-management subsystem of claim 1 that is further incorporated in a workflow-based cloud-management system that additionally includes an infrastructure-management-and-administration subsystem and the workflow-execution engine.

3. The automated-application-release-management subsystem of claim 1 wherein the automated-application-release-management controller controls execution of application-release-management pipelines, each application-release-management pipeline representing a sequence of tasks carried out by the automated-application-release-management subsystem to generate a releasable version of an application.

4. The automated-application-release-management subsystem of claim 3 wherein each application-release-management pipeline comprises one or more stages.

5. The automated-application-release-management subsystem of claim 4 wherein each application-release-management-pipeline stage comprises:
a set of one or more tasks; and
a plug-in framework that maps entrypoints in the tasks to entrypoints within sets of routine and/or function entrypoints in descriptors within the set of sets of descriptors.

6. The automated-application-release-management subsystem of claim 4 wherein the tasks include tasks of task types selected from among:
initialization tasks;
deployment tasks;
run-tests tasks;
gating-rule tasks; and
finalize tasks.

7. The automated-application-release-management subsystem of claim 4 wherein the dashboard-display component:
uses information in a data structure that represents a user to select a persona for the user;
uses metrics associated with the persona to retrieve stored data output by one or more pipeline stages for display to the user;
renders the retrieved data for display through a persona-based dashboard; and
displays the persona-based dashboard to the user.

8. The automated-application-release-management subsystem of claim 7 wherein the dashboard-display component retrieves stored data corresponding to a data context using a data-context identifier stored within discrete sets of stored data that identify the stored data as belonging to the data context.

9. The automated-application-release-management subsystem of claim 8 wherein the data context is one of:
a context associated with a particular request for a service submitted to the automated-application-release-management subsystem; and
a context associated with one of a particular stage or task of an application-release-management pipeline.

10. The automated-application-release-management subsystem of claim 7 wherein a persona includes:
a set of metrics, each metric specifying one or more data items in the data output by the stages and tasks of an application-release-management pipeline; and
information used by the dashboard-display component to display a dashboard, including one or more display features that display data corresponding to one or more metrics in the set of metrics.

11. The automated-application-release-management subsystem of claim 7 wherein each persona corresponds to a type of job.

12. The automated-application-release-management subsystem of claim 11 wherein the automated-application-release-management subsystem stores a persona for each of:
application developers;
project managers;
release engineers; and
administrators.

13. The automated-application-release-management subsystem of claim 7 wherein the dashboard-display component additionally employs identification information for the user included in the data structure that represents the user, along with the persona, to individualize the dashboard displayed to the user by retrieve data specific to the user.

14. A method that displays data output by an automated-application-release-management subsystem that includes one or more application-release-management pipelines, each application-release-management pipeline representing a sequence of tasks carried out by the automated-application-release-management subsystem to generate a releasable version of an application and each application-release-management pipeline comprises one or more stages, the automated-application-release-management subsystem operating within a computing facility having multiple servers, data-storage devices, and one or more internal networks, the method comprising:
using information, by a dashboard-display component of the automated-application-release-management subsystem, in a data structure that represents a user to select a persona for the user;
using metrics, by the dashboard-display component, associated with the persona to retrieve stored data output by one or more pipeline stages for display to the user;
rendering, by the dashboard-display component, the retrieved data for display through a persona-based dashboard; and
displaying the persona-based dashboard to the user.

15. The method of claim 14 further including:
retrieving stored data corresponding to a data context using a data-context identifier stored within discrete sets of stored data that identify the stored data as belonging to the data context.

16. The method of claim 15 wherein the data context is one of:
a context associated with a particular request for a service submitted to the automated-application-release-management subsystem; and
a context associated with one of a particular stage or task of an application-release-management pipeline.

17. The method of claim 14 wherein a persona includes:
a set of metrics, each metric specifying one or more data items in the data output by the stages and tasks of an application-release-management pipeline; and
information used by the dashboard-display component to display a dashboard, including one or more display features that display data corresponding to one or more metrics in the set of metrics.

18. The method of claim 14
wherein each persona corresponds to a type of job; and
wherein the automated-application-release-management subsystem stores a persona for each of
application developers,
project managers,
release engineers, and
administrators.

19. The method of claim 14 further including:
additionally employing identification information for the user included in the data structure that represents the user, along with the persona, to individualize the dashboard displayed to the user by retrieve data specific to the user.

20. Computer instructions, stored within one or more physical data-storage devices, that, when executed on one or more processors within a computing facility having multiple servers, data-storage devices, and one or more internal networks, control the computing facility to displays data output by an automated-application-release-management subsystem, operating within the computing facility, that includes one or more application-release-management pipelines, each application-release-management pipeline representing a sequence of tasks carried out by the automated-application-release-management subsystem to generate a releasable version of an application and each application-release-management pipeline comprises one or more stages, by:
using information, by a dashboard-display component of the automated-application-release-management subsystem, in a data structure that represents a user to select a persona for the user;
using metrics, by the dashboard-display component, associated with the persona to retrieve stored data output by one or more pipeline stages for display to the user;
rendering, by the dashboard-display component, the retrieved data for display through a persona-based dashboard; and
displaying the persona-based dashboard to the user.
